(19) United States
(12) Patent Application Publication
(10) Pub. No.: US 2024/0271999 A1
(43) Pub. Date: Aug. 15, 2024

(54) SPECTROSCOPIC ANALYSIS DEVICE AND INTERFERING LIGHT FORMATION MECHANISM

(71) Applicant: Tsubasa SAITO, Takamatsu-shi (JP)

(72) Inventor: Tsubasa SAITO, Takamatsu-shi (JP)

(21) Appl. No.: 18/586,536

(22) Filed: Feb. 25, 2024

Related U.S. Application Data
(63) Continuation of application No. PCT/JP2023/006722, filed on Feb. 24, 2023.

(30) Foreign Application Priority Data
Feb. 28, 2022 (JP) 2022-029016
May 11, 2022 (JP) 2022-078453
Feb. 17, 2023 (JP) 2023-023684

(51) Int. Cl. G01J 3/26; G01J 3/02; G01J 3/18; G01J 3/28; G01J 3/453

(52) U.S. Cl. CPC G01J 3/26; G01J 3/0208; G01J 3/021; G01J 3/0216; G01J 3/0237; G01J 3/0291; G01J 3/1804; G01J 3/2823; G01J 3/4535; G01J 2003/2843

(57) ABSTRACT

The present invention includes: a light supply part; an interfering light formation part; and a detection part, in which the interfering light formation part includes a fixed reflection part, a movable reflection part, and a moving part that moves and fixes the movable reflection part along a base plane, the fixed reflection part includes a first reflection surface that reflects supplied light supplied from the light supply part and a second reflection surface provided so as to be plane-symmetrical with the first reflection surface with respect to the base plane and to be orthogonal to the first reflection surface, and the movable reflection part includes a third reflection surface and a fourth reflection surface parallel to a first reflection surface and a second reflection surface of the fixed reflection part, respectively.

### TECHNICAL FIELD

The present invention relates to a spectroscopic analysis device and an interfering light formation mechanism.

### BACKGROUND ART

When light is applied to gas, liquid, solid, or the like (hereinafter simply referred to as “gas or the like”), the wavelength of the light transmitted through the gas or the like or the light reflected by the gas or the like (hereinafter referred to as “object light”) varies depending on the substances present in the gas or the like. In this situation, there is a technique using a spectroscopic technology as a method using the wavelength of the object light to discriminate and identify the substance present in the gas or the like. In the technique using the spectroscopic technology, the frequency spectrum and intensity of the object light is used to enable the substance present in the gas or the like to be discriminated and identified and the concentration of the substance to be grasped (hereinafter sometimes referred to as “discrimination and identification or the like of the substance”).

Known techniques using the spectroscopic technology include wavelength-dispersive spectroscopy and Fourier spectroscopy.

The wavelength-dispersive spectroscopy can perform discrimination and identification or the like of the substance by utilizing the fact that the diffraction angle varies depending on the wavelength of the object light when the object light is applied to the diffraction grating.

The Fourier spectroscopy is spectroscopy utilizing phase-shift interference with a Michelson-type two-beam interference optical system, which is a technology involving formation of an interferogram and mathematical Fourier transform of the interferogram to obtain a spectral characteristic in order to discriminate and identify the substance.

As spectroscopic analysis devices utilizing this Fourier spectroscopy to perform discrimination and identification or the like of the substance, technologies described in Patent Literatures 1 and 2 have been developed.

First, Patent Literature 1 discloses a device that uses micro electro-mechanical systems (MEMS) as actuators to form interfering light to be used for spectroscopic analysis. This device has a mechanism that forms outgoing light, which is interfering light, from incident light, and is configured so that the optical-axis direction of the incident light and the optical-axis direction of the outgoing light are coaxial with each other. For example, Patent Literature 1 discloses, as a mechanism that forms interfering light, a mechanism provided with a splitter 30b including first and second reflection surfaces and third and fourth reflection surfaces symmetrical to the optical axis of the incident light, a movable mirror 50 having orthogonal surfaces facing the first and third reflection surfaces, and a fixed corner reflector 60 having orthogonal surfaces facing the second and fourth reflection surfaces. In addition, Patent Literature 1 discloses that the movable mirror 50 of the mechanism that forms the interfering light moves in a direction of 90° to the optical axis of the incident light.

Since the mechanism that forms the interfering light of Patent Literature 1 has the configuration as described above, when light is made incident on the mechanism that forms interfering light, interfering light is formed as follows.

First, incident light is made incident on the splitter 30b, and then the incident light is reflected at the first and second reflection surfaces of the splitter 30b, respectively, to be divided into two beams of light, and the divided two beams of light are made incident on the movable mirror 50 and the fixed corner reflector 60, respectively. The respective beams of light made incident on the movable mirror 50 and the fixed corner reflector 60 are reflected at the movable mirror 50 and the fixed corner reflector 60, respectively, and made incident on the third and fourth reflection surfaces of the splitter 30b, respectively. The beams of light made incident on the third and fourth reflection surfaces of the splitter 30b are reflected at the third and fourth reflection surfaces of the splitter 30b, respectively, and made incident on the spatial combiner output 70. The beams made incident from the third and fourth reflection surfaces of the splitter 30b become the interfering light through the spatial combiner output 70, and thus the interfering light is made incident on the ditecter 610.

Here, if the movable mirror 50 moves, the two beams of light reflected at the first and second reflection surfaces of the splitter 30b have a difference generated in optical path length (optical path length difference) to where the light is made incident on the spatial combiner output 70. Since this optical path length difference changes depending on the movement amount of the movable mirror 50, detecting the intensity of the interfering light by the ditecter 610 while moving the movable mirror 50 allows an interferogram to be formed on the basis of the intensity of the detected interfering light. That is, in the device of Patent Literature 1, assuming that the incident light incident on the mechanism that forms the interfering light is object light and moving the movable mirror 50 while making the incident light be incident on the mechanism enables formation of the interferogram based on the object light, and it is possible to perform discrimination and identification or the like of the substance that generates the object light on the basis of this interferogram.

Furthermore, the spectroscopic analysis device of Patent Literature 2 includes a dividing optical system that allows multi-wavelength light emitted in various directions from measurement points of an object to be measured to be made incident, an image-forming optical system that directs the multi-wavelength light transmitted through the dividing optical system to almost the same point to form an interference image, a detection part that detects the light intensity of the interference image, an optical path length difference increasing/decreasing means for increasing/decreasing the relative optical path length difference between a part of the multi-wavelength light travelling from the dividing optical system toward the image-forming optical system and the remaining part of the multi-wavelength light, and a processing part that obtains the interferogram of each measurement point of the object to be measured on the basis of the light intensity change detected by the detection part by increasing/decreasing the optical path length difference by the optical path length difference increasing/decreasing means, and performs Fourier transform of the interferogram to acquire a spectrum.

In the spectroscopic analysis device of Patent Literature 2, the dividing optical system has a configuration in which the multi-wavelength light emitted in various directions from measurement points of the object to be measured is divided and directed into a first reflection part and a second reflection part. Furthermore, the optical path length difference increasing/decreasing means is configured to move the first and second reflection parts relative to each other to increase and decrease the optical path length difference between the multi-wavelength light traveling from the dividing optical system via the first reflection part toward the image-forming optical system and the multi-wavelength light traveling from the dividing optical system via the second reflection part toward the image-forming optical system.

Patent Literature 2 further describes that disposing the reflection surfaces of the first and second reflection parts with inclination of 45° with respect to the optical axes of the parallel beams each transmitted through the dividing optical system enables the light reflected at the first and second reflection parts to be directed to the image-forming optical system as it is.

### CITATION LIST

### Patent Literature

Patent Literature 1: US 2014/0192365 A
Patent Literature 2: Japanese Patent No. 5120873

### DISCLOSURE OF INVENTION

### Technical Problem

Meanwhile, the Michelson-type two-beam interference optical system described above and the spectroscopic analysis device in Patent Literatures 1 and 2, both of which form the interferogram by forming images of the divided beams at the same position, are characterized as follows.

First, the Michelson-type two-beam interference optical system can precisely align the image-formation positions of the divided beams, but has a problem that even microvibrations affect the interference due to its device configuration. Moreover, there is also a problem that separating the beam into two beams using a beam splitter leads to reduction in the light utilization ratio, making measurement difficult unless the object light has strong intensity.

Compared with the Michelson-type two-beam interference optical system, the spectroscopic analysis device of Patent Literature 1 can reduce the influence of vibration or the like on interference to some extent, but has a problem that, similar to the Michelson-type two-beam interference optical system, dividing the incident light into two beams of light using the splitter 30b results in a low light utilization ratio.

On the other hand, in the spectroscopic analysis device of Patent Literature 2, all of the light rays transmitted through the dividing optical system can be used for analysis, resulting in high light utilization efficiency and enabling measurement even with weak intensity of the object light. However, when the optical path length difference between the beams divided by the dividing optical systems is increased/decreased by the optical path length difference increasing/decreasing means, misalignment occurs in the image-formation positions of the beams. This causes a problem that misalignment occurs in the positions of forming the interference images when the measurement target is measured in two dimensions, resulting in low spatial resolution.

In view of the above circumstances, an object of the present invention is to provide a spectroscopic analysis device and an interfering light formation mechanism that can improve the robustness of the device against disturbance and can increase the light utilization ratio and the spatial resolution.

### Solution to Problem

A spectroscopic analysis device of the present invention includes: a light supply part; an interfering light formation part that forms interfering light from supplied light supplied from the light supply part; and a detection part that detects light intensity of the interfering light formed by the interfering light formation part, in which the interfering light formation part includes a fixed reflection part whose movement is fixed, a movable reflection part provided to be movable along a base plane parallel to an optical axis of the supplied light supplied from the light supply part, and a moving part that moves and fixes the movable reflection part along the base plane, the fixed reflection part includes a first reflection surface that reflects the supplied light supplied from the light supply part and a second reflection surface provided to be plane-symmetrical with the first reflection surface with respect to the base plane and to be orthogonal to the first reflection surface, and the movable reflection part includes a third reflection surface and a fourth reflection surface parallel to the first reflection surface and the second reflection surface of the fixed reflection part, respectively.

### Advantageous Effects of Invention

According to the present invention, the optical path length is changed by moving the movable reflection part linearly and parallel to the optical-axis direction of the supplied light, which improves the robustness of the device against external disturbance, prevents misalignment of the image-formation positions, and also improves the spatial resolution of measurement. Moreover, since only the reflection of light is used to generate the optical path length difference, it is possible to increase the light utilization efficiency.

### BRIEF DESCRIPTION OF DRAWINGS

FIGS. 1(A) to 1(C) are schematic explanatory diagrams of an interfering light formation mechanism M of a first embodiment, of which FIG. 1(A) illustrates a schematic cross-section of an A-A line in FIG. 1(B), FIG. 1(B) illustrates a schematic cross-section of a B-B line in FIG. 1(A), and FIG. 1(C) illustrates a schematic cross-section of a C-C line in FIG. 1(B).

FIGS. 2(A) to 2(C) are schematic explanatory diagrams of a state in which a movable reflection part MR of the interfering light formation mechanism M of the first embodiment is moved, of which FIG. 2(A) is a plan view, FIG. 2(B) illustrates a schematic cross-section of a B-B line in FIG. 2(A), and FIG. 2(C) is a bottom view of FIG. 2(A).

FIGS. 3(A) to 3(C) are schematic explanatory diagrams of a spectroscopic analysis device 1 having the interfering light formation mechanism M of the first embodiment, of which FIG. 3(A) illustrates a schematic cross-section of an A-A line in FIG. 3(B), FIG. 3(B) illustrates a schematic cross-section of a B-B line in FIG. 3(A), and FIG. 3(C) illustrates a schematic cross-section of a C-C line in FIG. 3(B).

FIGS. 4(A) to 4(C) are schematic explanatory diagrams of a state in which a movable reflection part 20 of the spectroscopic analysis device 1 having the interfering light formation mechanism M of the first embodiment is moved, of which FIG. 4(A) is a plan view, FIG. 4(B) illustrates a schematic cross-section of a B-B line in FIG. 4(A), and FIG. 4(C) illustrates a schematic cross-section of a C-C line in FIG. 4(B).

FIGS. 5(A) to 5(C) are schematic explanatory diagrams of the spectroscopic analysis device 1 having the interfering light formation mechanism M of the first embodiment provided with a light-traveling direction change member 29, of which FIG. 5(A) illustrates a schematic cross-section of an A-A line in FIG. 5(B), FIG. 5(B) illustrates a schematic cross-section of a B-B line in FIG. 5(A), and FIG. 5(C) illustrates a schematic cross-section of a C-C line in FIG. 5(B).

FIGS. 6(A) to 6(C) are schematic explanatory diagrams of an interfering light formation mechanism MA of a second embodiment, of which FIG. 6(A) illustrates a schematic cross-section of an A-A line in FIG. 6(B), FIG. 6(B) illustrates a schematic cross-section of a B-B line in FIG. 6(A), and FIG. 6(C) illustrates a schematic cross-section of a C-C line in FIG. 6(B).

FIGS. 7(A) to 7(C) are schematic explanatory diagrams of a state in which a second reflection part R2 of the interfering light formation mechanism MA of the second embodiment is moved, of which FIG. 7(A) is a plan view, FIG. 7(B) illustrates a schematic cross-section of a B-B line in FIG. 7(A), and FIG. 7(C) illustrates a bottom view of FIG. 7(A).

FIG. 8 is a schematic perspective view of a spectroscopic analysis device 1A having the interfering light formation mechanism MA of the second embodiment.

FIG. 9(A) is a schematic plan view of the spectroscopic analysis device 1A having the interfering light formation mechanism MA of the second embodiment, and FIG. 9(B) is a B-arrow view of FIG. 9(A).

FIG. 10(A) is an arrow view taken along a VA-VA line of FIG. 4(A), and FIG. 10(B) is an arrow view taken along a VB-VB line of FIG. 4(B).

FIGS. 11(A) to 11(B) are explanatory diagrams of optical path length change of the spectroscopic analysis device 1A having the interfering light formation mechanism MA of the second embodiment, of which FIG. 11(A) illustrates a state in which a reflection surface 17a of a first mirror 17 and a reflection surface 18a of a second mirror 18 are flush with a reflection surface 21a of a third mirror 21 and a reflection surface 22a of a fourth mirror 22, and FIG. 11(B) illustrates a state in which the reflection surface 21a of the third mirror 21 and the reflection surface 22a of the fourth mirror 22 are separated from an incident reflection surface 12a of an incident member 12 and an outgoing reflection surface 13a of an outgoing member 13.

FIG. 12 is a schematic perspective view of the spectroscopic analysis device 1A having the interfering light formation mechanism MA of the second embodiment from which a frame 2 other than a wall 2b is excluded.

FIGS. 13(A) to 13(C) are schematic explanatory diagrams of an interfering light formation mechanism MB of a third embodiment, of which FIG. 13(A) illustrates a schematic cross-section of an A-A line in FIG. 13(B), FIG. 13(B) illustrates a schematic cross-section of a B-B line in FIG. 13(A), and FIG. 13(C) illustrates a schematic cross-section of a C-C line in FIG. 13(B).

FIGS. 14(A) to 14(C) are schematic explanatory diagrams of a state in which a second reflection part R2 of the interfering light formation mechanism MB of another embodiment is moved, of which FIG. 14(A) is a plan view, FIG. 14(B) illustrates a schematic cross-section of a B-B line in FIG. 14(A), and FIG. 14(C) illustrates a bottom view of FIG. 14(A).

FIGS. 15(A), 15(B), and 15(C) are diagrams showing experimental results.

FIG. 16(A) is an interferogram formed from signals detected by a CMOS camera, and FIG. 16(B) is a visible image of gas formed from the interferogram of pixels.

### DESCRIPTION OF EMBODIMENTS

The spectroscopic analysis device of the present embodiment is a spectroscopic analysis device that uses Fourier spectroscopy to discriminate and identify a measurement target or a substance contained in the measurement target, and is characterized by a mechanism that forms interfering light.

The measurement target whose substance is to be discriminated and identified by the spectroscopic analysis device of the present embodiment is not particularly limited. The measurement target may be gas, liquid, or solid. Also, the substance to be discriminated and identified is not limited, and may be a substance that allows discrimination and identification of gas, liquid, or solid contained in the measurement target. For example, in the case of gas, it is possible to discriminate and identify carbon-based gases such as methane, carbon dioxide, and the like, natural gases such as ammonia and the like, and industrial gases.

### <Interfering Light Formation Mechanism of Present Embodiment>

First, description will be made on an interfering light formation mechanism M of the present embodiment (hereinafter sometimes simply referred to as “interfering light formation mechanism M”).

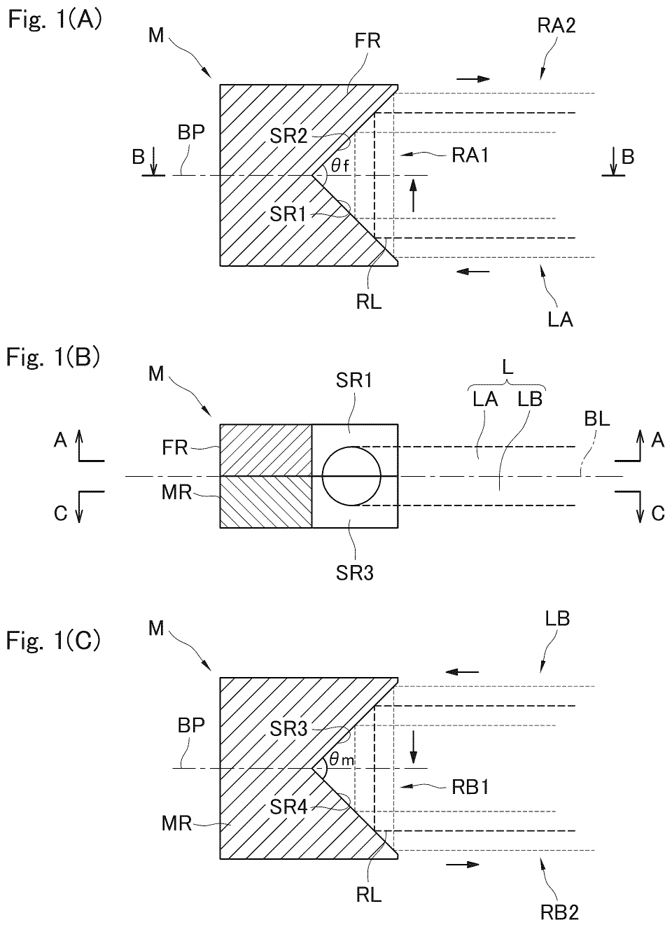

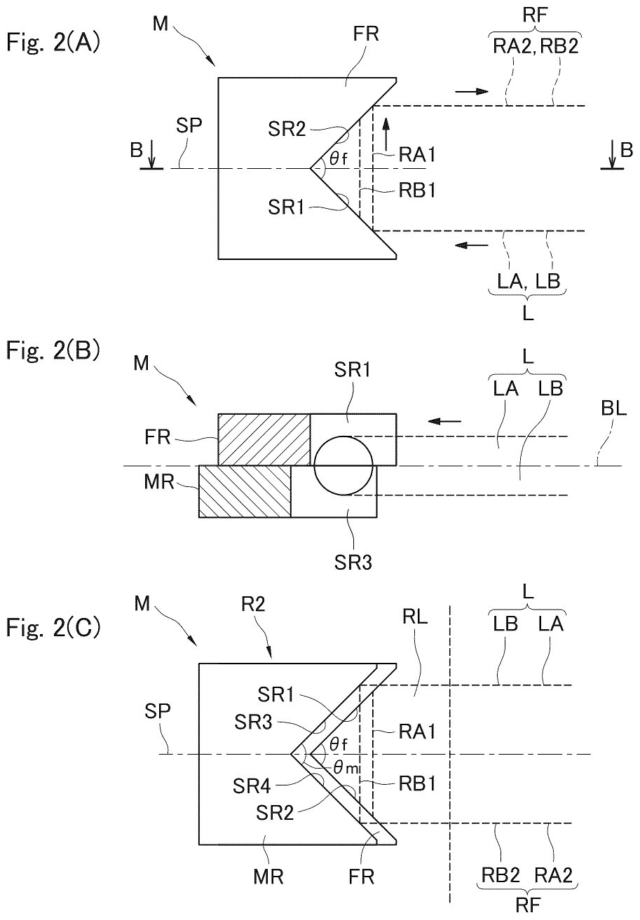

As shown in FIG. 1 and FIGS. 2, the interfering light formation mechanism M has a fixed reflection part FR, a movable reflection part MR, and a moving part (see FIG. 1(B) and FIG. 2(B)).

### <Fixed Reflection Part FR>

As shown in FIG. 1 and FIGS. 2, the fixed reflection part FR includes a first reflection surface SR1, which is a mirror-finished surface, and a second reflection surface SR2, which is a mirror-finished surface. The first reflection surface SR1 and the second reflection surface SR2 are provided plane-symmetrically with respect to a base plane BP. Moreover, the first reflection surface SR1 and the second reflection surface SR2 are provided so that an angle θf formed therebetween becomes a right angle.

### <Movable Reflection Part MR>

As shown in FIG. 1 and FIGS. 2, the movable reflection part MR has a third reflection surface SR3, which is a mirror-finished surface, and a fourth reflection surface SR4, which is a mirror-finished surface. The third reflection surface SR3 and the fourth reflection surface SR4 are provided plane-symmetrically with respect to the base plane BP. Moreover, the third reflection surface SR3 and the fourth reflection surface SR4 are provided so that an angle θm formed therebetween becomes a right angle. That is, the third reflection surface SR3 and the fourth reflection surface SR4 are provided so that the angle θm formed therebetween becomes the same angle as the angle θf formed between the first reflection surface SR1 and the second reflection surface SR2.

Furthermore, the movable reflection part MR is provided alongside the fixed reflection part FR (see FIG. 1(B) and FIG. 2(B)) and is provided to be movable relative to the fixed reflection part FR. Specifically, the movable reflection part MR is provided so as to move along the base plane BP, with maintaining a state in which the third reflection surface SR3 and the fourth reflection surface SR4 are parallel to the first reflection surface SR1 and the second reflection surface SR2, respectively. To be more specific, the movable reflection part MR is provided to be movable between a state in which the third reflection surface SR3 and the fourth reflection surface SR4 are flush with the first reflection surface SR1 and the second reflection surface SR2, respectively (reference state, see FIG. 1(B)) and a state in which the third reflection surface SR3 and the fourth reflection surface SR4 are moved from the reference state in the direction of the base plane BP with respect to the first reflection surface SR1 and the second reflection surface SR2 (see FIG. 2(B)). Moreover, in the reference state, the movable reflection part MR is provided adjacently to the fixed reflection part FR so as to form almost no gap between the end edge of the first reflection surface SR1 on the third reflection surface SR3 side (end edge in the downward direction for FIG. 1(B) and FIG. 2(B)) and the end edge of the third reflection surface SR3 on the first reflection surface SR1 side (end edge in the upward direction for FIG. 1(B) and FIG. 2(B)), and between the end edge of the second reflection surface SR2 on the fourth reflection surface SR4 side and the end edge of the fourth reflection surface SR4 on the second reflection surface SR2 side. For example, although the above gap is desirably not formed, the movable reflection part MR is provided alongside the fixed reflection part FR so that the gap, if any, is formed to be 0.2 mm or less, preferably 0.1 mm or less.

Note that FIG. 2(B) illustrates a case where the movable reflection part MR is moved so that the third reflection surface SR3 and the fourth reflection surface SR4 are positioned in the left direction (i.e., the direction opposite to the direction in which light becomes incident) from the reference state. However, the movable reflection part MR may be configured to move so that the third reflection surface SR3 and the fourth reflection surface SR4 are positioned in the right direction (i.e., the direction in which light becomes incident) from the reference state. As a matter of course, the movable reflection part MR may be configured so that the third reflection surface SR3 and the fourth reflection surface SR4 move in both the right direction and the left direction from the reference state.

### <Functions of Interfering Light Formation Mechanism M>

Since the interfering light formation mechanism M has the configuration as described above, when supplied light L is made incident on the first reflection surface SR1 and the third reflection surface SR3 of the interfering light formation mechanism M, the supplied light L is reflected in the following manner.

First, it is assumed that the supplied light L is parallel light whose optical axis is parallel to both the base plane BP and the movement direction of the movable reflection part MR, and that the supplied light L is made incident so that the intermediate line of the supplied light L (intermediate line in the up and down direction for FIG. 1(B) and FIG. 2(B)) is aligned with a borderline BL between the movable reflection part MR and the fixed reflection part FR.

When such supplied light L is made incident on the interfering light formation mechanism M, half of the supplied light L is made incident on the first reflection surface SR1, and the other half of the supplied light L is made incident on the third reflection surface SR3. That is, the supplied light L is made incident on either one of the first reflection surface SR1 and the third reflection surface SR3. Hereinafter, the supplied light L made incident on the first reflection surface SR1 is referred to as “supplied light LA”, and the supplied light L made incident on the third reflection surface SR3 is referred to as “supplied light LB”.

The supplied light LA is reflected toward the second reflection surface SR2 as reflected light RA1 maintaining the state of parallel light at the first reflection surface SR1 (see FIG. 1(A)). Similarly, the supplied light LB is reflected toward the fourth reflection surface SR4 as reflected light RB1 that maintains the state of parallel light at the third reflection surface SR3 and has an optical axis parallel to the optical axis of the reflected light RA1 (see FIG. 1(C)).

When the reflected light RA1 is made incident on the second reflection surface SR2, the reflected light RA1 is reflected as reflected light RA2 maintaining the state of parallel light at the second reflection surface SR2 (see FIG. 1(A)). Similarly, when the reflected light RB1 is made incident on the fourth reflection surface SR4, the reflected light RB1 is reflected as reflected light RB2 maintaining the state of parallel light at the fourth reflection surface SR4 (see FIG. 1(C)). Moreover, the reflected light RA2 and the reflected light RB2 become parallel light having optical axes that are parallel to each other and parallel to the base plane BP (see FIG. 1(A) and FIG. 1(C)). That is, the reflected light RA2 and the reflected light RB2 become parallel light having optical axes that are parallel to the optical axes of the supplied light LA and the supplied light LB made incident on the first reflection surface SR1 and the third reflection surface SR3, respectively and moving in opposite directions to the supplied light LA and the supplied light LB, respectively (see FIG. 1(A) and FIG. 1(C)).

The reflected light RA2 and the reflected light RB2 have a phase difference (optical path length difference) generated according to the movement amount of the movable reflection part MR in the direction parallel to the base plane BP. Therefore, the movement amount of the movable reflection part MR can be changed to collect the reflected light RA2 and the reflected light RB2 to form the interfering reflected light RF (see FIG. 2(C)).

Since the interfering light formation mechanism M of the present invention has the above configuration, the interfering reflected light RF can be formed using entirety of the supplied light L. Therefore, even if the intensity of the supplied light L is weak, the interfering reflected light RF can form an interference image that can form an interferogram with some degree of signal intensity.

Note that the angle θf formed between the first reflection surface SR1 and the second reflection surface SR2 and the angle θm formed between the third reflection surface SR3 and the fourth reflection surface SR4 may not necessarily be right angles. However, forming the angle θf and the angle θm at right angles enables the optical axis of the supplied light LA and the optical axis of the supplied light LB incident on the first reflection surface SR1 and the third reflection surface SR3, respectively, to be parallel with the optical axis of the reflected light RA2 and the optical axis of the reflected light RB2 reflected at the second reflection surface SR2 and the fourth reflection surface SR4, respectively. As a result, the device can be made compact and improved in its robustness.

### <Spectroscopic Analysis Device 1 of Present Embodiment>

Next, a spectroscopic analysis device 1 of the present embodiment will be described.

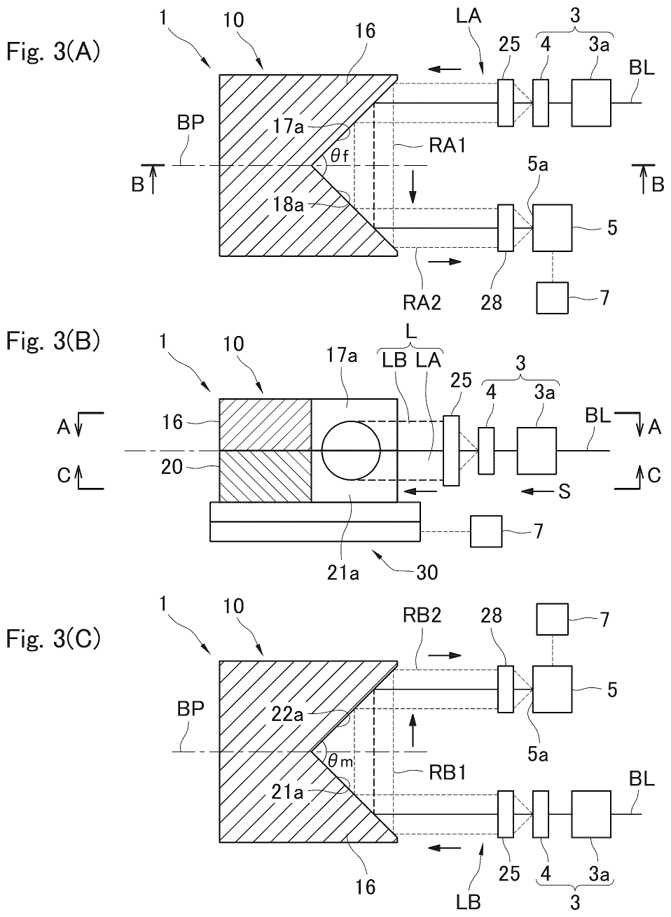

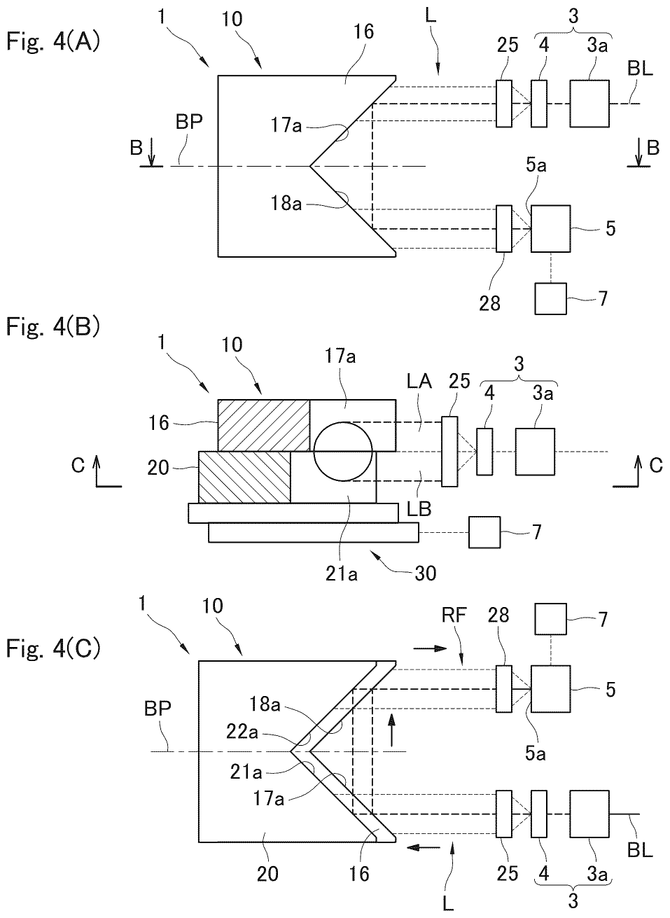

As shown in FIG. 3 and FIGS. 4, the spectroscopic analysis device 1 of the present embodiment is a device employing the interfering light formation mechanism M of the present embodiment described above, and has a light supply part 3, an interfering light formation part 10, a detection part 5, and a control part 7. Note that the interfering light formation part 10 has the configuration of the interfering light formation mechanism M of the present embodiment described above.

Hereinafter, description of configurations will be provided. The configurations provided below are examples, and a configuration other than the following configurations may be adopted as long as exerting similar functions.

Hereinafter, interfering reflected light RFA means the entirety of the supplied light LA, the reflected light RA1, and the reflected light RA2 described above, and interfering reflected light RFB means the entirety of the supplied light LB, the reflected light RB1, and the reflected light RB2. For example, the optical path length of the interfering reflected light RFA means the length totalizing the optical path lengths of the supplied light LA, the reflected light RA1, and the reflected light RA2, and the optical path length of the interfering reflected light RFB means the length totalizing the optical path lengths of the supplied light LB, the reflected light RB1, and the reflected light RB2.

Furthermore, the supplied light L is a concept that includes both the supplied light LA and the supplied light LB. That is, the entirety of light supplied from the light supply part 3 to the interfering light formation part 10 is the supplied light L. Furthermore, the interfering reflected light RF is a concept that includes both the interfering reflected light RFA and the interfering reflected light RFB. That is, the entirety of light supplied from the interfering light formation part 10 to the detection part 5 is the interfering reflected light RF.

### <Light Supply Part 3>

The light supply part 3, which supplies the object light BL to the interfering light formation part 10 as the supplied light L, has a supply part 3a and a diffraction grating 4. The supply part 3a supplies the object light to the interfering light formation part 10 as the supplied light L whose optical axis is parallel to the base plane BP of the interfering light formation part 10 and the movement direction of the movable reflection part 20. For example, as the supply part 3a, an optical fiber, a lens, a mirror, a reflective optical unit, or the like can be employed.

Furthermore, the diffraction grating 4 is provided between the supply part 3a and the interfering light formation part 10. The diffraction grating 4 functions as a deflection filter, and has a function of allowing only light of waves in a specific direction to pass through. Between the diffraction grating 4 and the interfering light formation part 10, an incident parallel light formation part 25 is provided.

### <Detection Part 5>

The detection part 5 has a function of measuring the light intensity of the interfering reflected light RF supplied from the interfering light formation part 10. Specifically, the detection part 5 has a detection surface 5a provided with light-receiving elements, and the detection part 5 is arranged at a position that allows an interference image to be formed on the detection surface 5a. The detection part 5 has a function of measuring the light intensity of interference fringes formed on the detection surface 5a. In addition, the detection part 5 has a function of supplying a signal related to the light intensity detected by the light-receiving elements of the detection surface 5a (light intensity of the interference fringes) to the control part 7.

The detection part 5 is not particularly limited as long as having the functions described above, and a two-dimensional CCD camera, a CMOS camera, or the like may be employed, for example. Like the two-dimensional CCD camera, by using the detection part 5 with the detection surface 5a having a plurality of light-receiving elements arrayed two-dimensionally, it is possible to obtain two-dimensional distribution of the substance in the measurement target. For example, in the measurement target, it also becomes possible to two-dimensionally acquire the presence position of the substance or acquire two-dimensional distribution of concentration or the like.

### <Control Part 7>

The control part 7 has an analysis function of analyzing a signal related to the light intensity of the interference image detected by the detection part 5. Specifically, the control part 7 has a function of forming an interferogram on the basis of information related to the optical path length difference between the interfering reflected light RFA and the interfering reflected light RFB and a signal related to the light intensity supplied from the detection part 5, and performing Fourier transform of the interferogram to acquire a spectral characteristic.

Note that the method by which the control part 7 acquires the information related to the optical path length difference between the interfering reflected light RFA and the interfering reflected light RFB is not particularly limited. For example, in the case of manually adjusting the movement amount of the moving part 30 of the interfering light formation part 10 (i.e., the movement amount of the movable reflection part 20), an operator may input the movement amount of the moving part 30 to the control part 7. Furthermore, in the case where the moving part 30 is configured to automatically move the movable reflection part 20, the movement amount of the moving part 30 may be input from the moving part 30 to the control part 7. Furthermore, in the case where the moving part 30 is configured to automatically move the movable reflection part 20, the control part 7 may have a function of controlling operation of the moving part 30 to control the operation amount of the movable reflection part 20. In such case, the control part 7 can set and adjust the optical path length difference between the interfering reflected light RFA and the interfering reflected light RFB.

Furthermore, in the case where the control part 7 has a function of controlling the movement amount of the movable reflection part 20, it is possible to match the movement of the movable reflection part 20, that is, the movement of the third reflection surface 21a and the fourth reflection surface 22a of the movable reflection part 20, with a frame rate of the detection part 5. That is, it becomes also possible for the detection part 5 to acquire the light intensity of the interfering reflected light RF at equal intervals, thus facilitating Fourier transform of the interferogram formed on the basis of the acquired light intensity. As a result, signal processing to acquire the spectral characteristic can be facilitated and data processing time can be shortened.

### <Interfering Light Formation Part 10>

As shown in FIG. 3 and FIGS. 4, the interfering light formation part 10 has a fixed reflection part 16 and a movable reflection part 20 having substantially the same configuration and function as the fixed reflection part FR and the movable reflection part MR of the interfering light formation mechanism M described above. To be specific, the interfering light formation part 10 has the fixed reflection part 16 with a first reflection surface 17a (corresponding to the first reflection surface SR1) and a second reflection surface 18a (corresponding to the second reflection surface SR2). In addition, the interfering light formation part 10 has the movable reflection part 20 provided to be movable relative to the fixed reflection part 16 in a direction parallel to the base plane BP and the optical axis of the supplied light L (hereinafter, sometimes simply referred to as “movement direction S”), the movable reflection part 20 having a third reflection surface 21a (corresponding to the first reflection surface SR3) and a fourth reflection surface 22a (corresponding to the second reflection surface SR4). In the following, description of portions having the equivalent configuration or equivalent disposition as the interfering light formation mechanism M of the present embodiment will be omitted as appropriate.

### <Fixed Reflection Part 16>

As shown in FIG. 3 and FIGS. 4, the fixed reflection part 16 includes the first reflection surface 17a (corresponding to the first reflection surface SR1), which is a mirror-finished surface, and the second reflection surface 18a (corresponding to the second reflection surface SR2), which is a mirror-finished surface. The first reflection surface 17a and the second reflection surface 18a are provided plane-symmetrically with respect to the base plane BP. Moreover, the first reflection surface 17a and the second reflection surface 18a are provided so that the angle θf formed therebetween becomes a right angle.

Note that the configuration for providing the first reflection surface 17a and the second reflection surface 18a on the fixed reflection part 16 is not particularly limited. The body of the fixed reflection part 16 may be processed to form the first reflection surface 17a and the second reflection surface 18a, or the fixed reflection part 16 may be provided with a member having a mirror-finished surface, such as a mirror, and use the mirror-finished surface of this member as the first reflection surface 17a and the second reflection surface 18a.

### <Movable Reflection Part 20>

As shown in FIG. 3 and FIGS. 4, the movable reflection part 20 includes the third reflection surface 21a (corresponding to the first reflection surface SR3), which is a mirror-finished surface, and the fourth reflection surface 22a (corresponding to the second reflection surface SR4), which is a mirror-finished surface. The third reflection surface 21a and the fourth reflection surface 22a are provided plane-symmetrically with respect to the base plane BP. Moreover, the third reflection surface 21a and the fourth reflection surface 22a are provided so that the angle θm formed therebetween becomes a right angle. That is, the third reflection surface 21a and the fourth reflection surface 22a are provided so that the angle θm formed therebetween becomes the same angle as the angle θf formed between the first reflection surface 17a and the second reflection surface 18a. Moreover, the movable reflection part 20 is provided to be movable relative to the fixed reflection part 16. Specifically, the movable reflection part 20 is provided to be movable relative to the fixed reflection part 16 along a direction parallel to the base plane BP and the optical axis of the supplied light L (hereinafter, sometimes simply referred to as “movement direction S”).

Note that the configuration for allowing the movable reflection part 20 to move relative to the fixed reflection part 16 along the movement direction S is not particularly limited. For example, a guide mechanism such as a rail or the like that guides the movable reflection part 20 along the movement direction S may be provided to make the movable reflection part 20 move by being guided by the guide mechanism, or a moving part 30 to be described later may have a mechanism that guides the movement of the movable reflection part 20.

Furthermore, the configuration for providing the third reflection surface 21a and the fourth reflection surface 22a on the movable reflection part 20 is not particularly limited. The body of the movable reflection part 20 may be processed to form the third reflection surface 21a and the fourth reflection surface 22a, or the movable reflection part 20 may be provided with a member having a mirror-finished surface, such as a mirror, and use the mirror-finished surface of this member as the third reflection surface 21a and the fourth reflection surface 22a.

### <Moving Part 30>

As shown in FIG. 3(B) and FIG. 4(B), the interfering light formation part 10 has the moving part 30 that moves the movable reflection part 20. The moving part 30 moves the movable reflection part 20 relative to the fixed reflection part 16 along a direction parallel to the base plane BP and the optical axis of the supplied light L (in the left and right direction for FIG. 3(B) and FIG. 4(B)). For example, a known moving device having a movable member (stage) that moves along the movement direction S, such as a commercially-available uniaxial stage, can be used as the moving part 30. In such case, the moving device may be installed so that the movement direction of the movable member is parallel to the optical-axis direction of the supplied light L, and the movable reflection part 20 may be attached to the movable member of the moving device to make the movable reflection part 20 move by the moving part 30. Furthermore, as described above, in a case where a guide mechanism such as a rail or the like that guides the movable reflection part 20 is provided, a device that can move the movable reflection part 20 along the rail or the like and fix the movement may be used as the moving part 30. For example, a device having a moving mechanism such as a cylinder mechanism, a ball screw mechanism, or the like may also be employed as the moving part 30.

Note that the moving part 30 desirably has a function of allowing the movable reflection part 20 to accurately move at constant velocity (for example, 30 μm/s or less) along the movement direction S.

Furthermore, the moving part 30 may be configured to manually or automatically move the movable reflection part 20. Note that, in the case where the moving part 30 is configured to automatically move the movable reflection part 20, it becomes easy to accurately adjust the optical path difference between the interfering reflected light RFA and the interfering reflected light RFB generated when the movable reflection part 20 moves. Furthermore, it is possible to obtain an advantage that the movable reflection part 20 can be moved at constant velocity.

### <Incident Parallel Light Formation Part 25>

As shown in FIG. 3 and FIGS. 4, the interfering light formation part 10 has the diffraction grating 4 of the light supply part 3, and an incident parallel light formation part 25 provided between the first reflection surface 17a of the fixed reflection part 16 and the third reflection surface 21a of the movable reflection part 20. The incident parallel light formation part 25 has a function of collimating the supplied light L released from the diffraction grating 4 of the light supply part 3 as parallel light and supplying the parallel light to the first reflection surface 17a of the fixed reflection part 16 and the third reflection surface 21a of the movable reflection part 20. As the incident parallel light formation part 25, it is possible to employ, for example, a collecting lens whose focal point is at the position of the diffraction grating 4. Note that the incident parallel light formation part 25 is not particularly limited as long as being able to form the focal point of the parallel light at the position of the diffraction grating 4 when the parallel light is collected.

Furthermore, instead of providing the incident parallel light formation part 25 in the interfering light formation part 10, a mechanism having the equivalent function as the incident parallel light formation part 25 may be provided in the light supply part 3. That is, such a configuration may be adopted in which the interfering light formation part 10 without the incident parallel light formation part 25 is provided and the light supply part 3 has the supply part 3a, the diffraction grating 4, and the collecting lens whose focal point is at the position of the diffraction grating 4. Furthermore, in addition to the light supply part 3 and the interfering light formation part 10, the incident parallel light formation part 25 may be provided between the light supply part 3 and the interfering light formation part 10.

### <Light Collection Part 28>

As shown in FIG. 3 and FIGS. 4, the interfering light formation part 10 has a light collection part 28 provided between the second reflection surface 18a of the fixed reflection part 16 and the fourth reflection surface 22a of the movable reflection part 20 and the detection part 5. The light collection part 28 collects the reflected light RA2 and the reflected light RB2 supplied from the second reflection surface 18a of the fixed reflection part 16 and the fourth reflection surface 22a of the movable reflection part 20, respectively, to form an interference image on the detection surface 5a of the detection part 5. For example, a focusing lens whose focal point is at the position of the detection surface 5a of the detection part 5 can be employed as the light collection part 28.

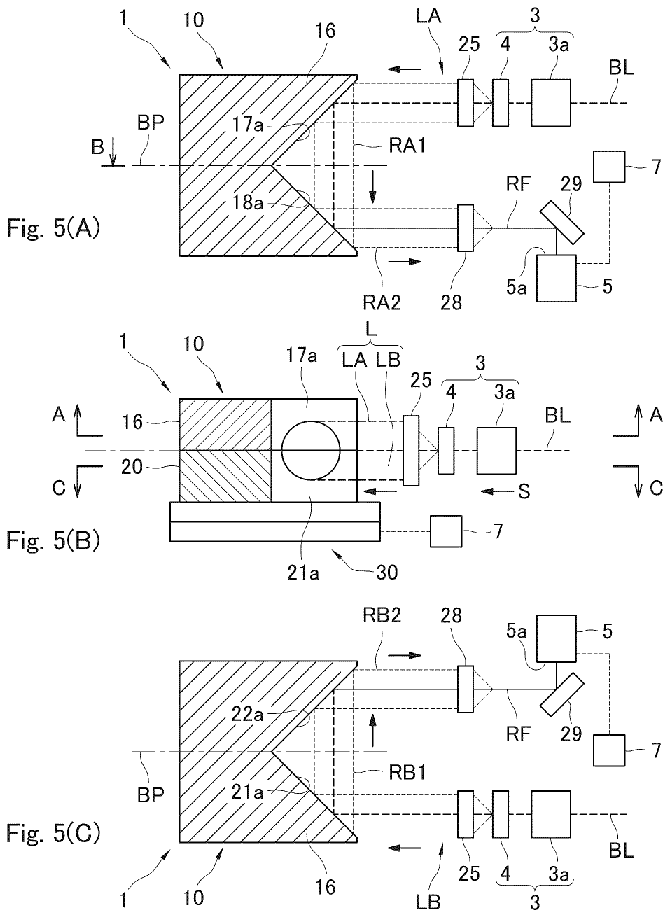

Furthermore, as shown in FIGS. 5, the light collection part 28 may have a light-traveling direction change member 29 that reflects the interfering reflected light RF collected at the light collection part 28 and changes the traveling direction of the interfering reflected light RF. For example, by providing a reflection mirror as the light-traveling direction change member 29, the traveling direction of the interfering reflected light RF can be bent at a desired angle (90° for FIG. 5). Such configuration eliminates a need to dispose the detection part 5 in series with the interfering light formation part 10 along the optical-axis direction of the supplied light L and the interfering reflected light RF. As a result, flexibility of disposition of the interfering light formation part 10 and the detection part 5 is increased, and the spectroscopic analysis device 1 of the present embodiment is easily downsized.

Note that, instead of providing the light collection part 28 in the interfering light formation part 10, a mechanism having the equivalent function as the light collection part 28 may be provided in the detection part 5. That is, such a configuration may be adopted in which the interfering light formation part 10 without the light collection part 28 is provided and the detection part 5 has a camera or the like having the detection surface 5a and the collecting lens whose focal point is at the position of the detection surface 5a. In such case, the detection part 5 may also have the light-traveling direction change member 29, if necessary. Furthermore, in addition to the detection part 5 and the interfering light formation part 10, the light collection part 28 may be provided between the light supply part 3 and the interfering light formation part 10.

Since the spectroscopic analysis device 1 of the present embodiment has the configuration as described above, making the object light supplied from the measurement target through the light supply part 3 incident on the interfering light formation part 10 enables formation of an interference image on the detection surface 5a of the detection part 5. As a result, by analyzing the interference image with the control part 7, it is possible to discriminate and identify the measurement target or a substance contained in the measurement target.

Note that the spectroscopic analysis device 1 of the present embodiment may not necessarily have the control part 7. In such case, the detection part 5 or a device different from the detection part 5 may be provided with a function of storing, as measurement data, a signal related to the light intensity measured on the detection surface 5a of the detection part 5 and a signal related to the optical path length difference between the interfering reflected light RFA and interfering reflected light LFB, and the measurement data stored using this function may be analyzed by another analysis device.

### <Interfering Light Formation Mechanism MA of Second Embodiment>

Next, description will be made on an interfering light formation mechanism MA of a second embodiment (hereinafter sometimes simply referred to as “interfering light formation mechanism MA”).

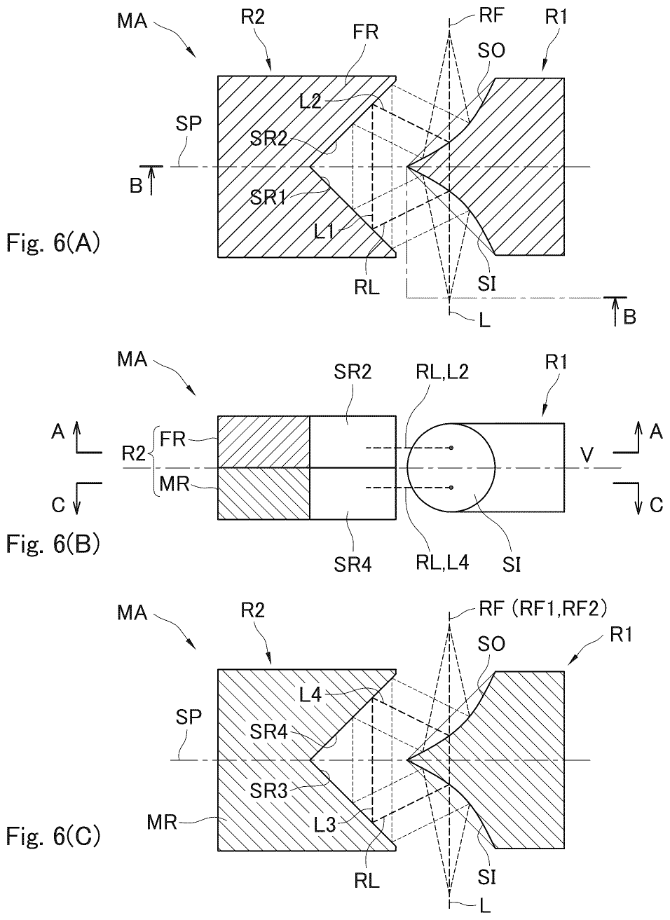

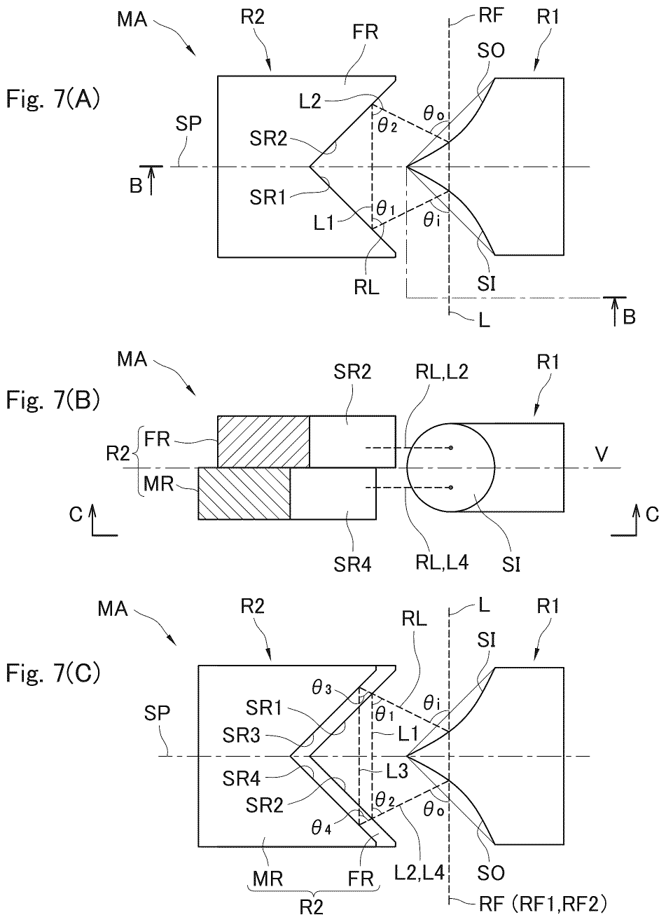

As shown in FIG. 6 and FIGS. 7, the interfering light formation mechanism MA has a first reflection part R1 and a second reflection part R2.

### <First Reflection Part R1>

As shown in FIG. 6 and FIGS. 7, the first reflection part R1 includes an incident reflection surface SI and an outgoing reflection surface SO provided so as to be mutually plane-symmetrical with respect to a symmetry plane SP. Both the incident reflection surface SI and the outgoing reflection surface SO are formed as parabolic surfaces. Specifically, the incident reflection surface SI and the outgoing reflection surface SO are formed in a shape that allows the light made incident to be collected and collimated as parallel light. For example, the incident reflection surface SI (or the outgoing reflection surface SO) is formed so as to allow non-parallel light made incident on the incident reflection surface SI (or the outgoing reflection surface SO) to be reflected as parallel light, and to allow the parallel light made incident on the incident reflection surface SI (or the outgoing reflection surface SO) to be collected at a predetermined focal point.

Note that, in the above configuration, in the first reflection part R1, a portion where the incident reflection surface SI described above is provided corresponds to an incident part in claim 6 of CLAIMS, and a portion where the outgoing reflection surface SO described above is provided corresponds to an outgoing part in claim 6 of CLAIMS.

### <Second Reflection Part R2>

As shown in FIG. 6 and FIGS. 7, the second reflection part R2 is provided so as to face the incident reflection surface SI and the outgoing reflection surface SO of the first reflection part R1. The second reflection part R2 has the fixed reflection part FR whose movement is fixed with respect to the first reflection part R1, and a movable reflection part MR provided to be movable with respect to the first reflection part R1 (see FIG. 6(B) and FIG. 7(B)).

### <Fixed Reflection Part FR>

As shown in FIGS. 6 and 7, the fixed reflection part FR includes the first reflection surface SR1 and the second reflection surface SR2 provided plane-symmetrically with respect to the symmetry plane SP.

The first reflection surface SR1 is provided so as to face the incident reflection surface SI of the first reflection part R1. Specifically, the first reflection surface SR1 is provided to allow, when light parallel to the normal of the symmetry plane SP (hereinafter referred to as “supplied light L”) is made incident on the incident reflection surface SI of the first reflection part R1, a part of the reflected light of the incident light (hereinafter referred to as “incident light RL”) (for FIG. 6(B) and FIG. 7(B), light reflected at the upper portion (portion above a plane V by which the incident reflection surface SI is divided into two portions upward and downward) of the incident reflection surface SI) to be incident thereon. Moreover, the first reflection surface SR1 is provided so that the optical axis of the reflected light that has reflected the incident light RL (hereinafter referred to as “first reflected light L1”) becomes parallel to the normal of the symmetry plane SP (in other words, the optical axis of the supplied light L). That is, the first reflection surface SR1 is provided so that a reflection angle θ1 thereof (angle θ1 formed between the incident light RL and the first reflected light L1 in FIG. 7(A)) becomes the same angle as a reflection angle θi of the incident reflection surface SI (angle θi formed between the supplied light L and the incident light RL in FIG. 2(A)). Note that the arrangement as described above leads the entirety of the first reflected light L1 to be reflected toward the second reflection surface SR2.

The second reflection surface SR2 is provided so as to face the outgoing reflection surface SO of the first reflection part R1. Specifically, the second reflection surface SR2 is provided so that, when the first reflected light L1 made incident from the first reflection surface SR1 is reflected by the second reflection surface SR2, the reflected light (hereinafter referred to as “second reflected light L2”) becomes incident on the outgoing reflection surface SO (specifically, the upper portion of the outgoing reflection surface SO). Moreover, the second reflection surface SR2 is provided so that the angle formed between the optical axis of the second reflected light L2 and the symmetry plane SP becomes the same angle as the angle formed between the optical axis of the incident light LI and the symmetry plane SP. The arrangement as described above leads the entirety of the second reflected light L2 to be reflected toward the outgoing reflection surface SO.

In this situation, since the second reflection surface SR2 is provided plane-symmetrically with the first reflection surface SR1 with respect to the symmetry plane SP, with the above configuration, a reflection angle θo of the outgoing reflection surface SO (angle θo formed between the second reflected light L2 and the light reflected at the outgoing reflection surface SO in FIG. 7(A) (hereinafter referred to as “interfering reflected light RF”)) becomes the same as the reflection angle θi of the incident reflection surface SI. Therefore, if the second reflection surface SR2 is provided as described above, a reflection angle θ2 of the second reflection surface SR2 (angle θ2 formed between the first reflected light L1 and the second reflected light L2 in FIG. 2(A)) becomes the same angle as the reflection angle θo of the outgoing reflection surface SO.

### <Movable Reflection Part MR>

As shown in FIG. 6(C) and FIG. 7(C), the movable reflection part MR has the third reflection surface SR3 and the fourth reflection surface SR4 provided plane-symmetrically with respect to the symmetry plane SP.

The third reflection surface SR3, which is a surface provided in parallel to the first reflection surface SR1, is provided so as to have a positional relationship to the incident reflection surface SI substantially similar to the positional relationship of the first reflection surface SR1. That is, the third reflection surface SR3 is provided so as to allow, when the supplied light L is made incident on the incident reflection surface SI of the first reflection part R1, a part of the incident light RL (for FIG. 6(B) and FIG. 7(B), light reflected at the lower portion (portion below the plane V) of the incident reflection surface SI) to be incident thereon. Moreover, the third reflection surface SR3 is provided so that the optical axis of the reflected light that has reflected the incident light RL (hereinafter referred to as “third reflected light L3”) becomes parallel to the normal of the symmetry plane SP (in other words, the optical axis of the supplied light L). That is, the third reflection surface SR3 is provided so that a reflection angle θ3 thereof (angle θ3 formed between the incident light RL and the third reflected light L3 in FIG. 7(C)) becomes the same angle as the reflection angle θi of the incident reflection surface SI. Note that the arrangement as described above leads the entirety of the third reflected light L3 to be reflected toward the fourth reflection surface SR4.

The fourth reflection surface SR4, which is a surface provided in parallel to the second reflection surface SR2, is provided so as to have a positional relationship to the outgoing reflection surface SO substantially similar to the positional relationship of the second reflection surface SR2. That is, the fourth reflection surface SR4 is provided so that, when the third reflected light L3 made incident from the third reflection surface SR3 is reflected by the fourth reflection surface SR4, the reflected light (hereinafter referred to as “fourth reflected light L4”) becomes incident on the outgoing reflection surface SO (specifically, the lower portion of the outgoing reflection surface SO). Moreover, the fourth reflection surface SR4 is provided so that the angle formed between the optical axis of the fourth reflected light L4 and the symmetry plane SP becomes the same angle as the angle formed between the optical axis of the incident light LI and the symmetry plane SP. That is, the fourth reflection surface SR4 is provided so that a reflection angle θ4 thereof (angle θ4 formed between the third reflected light L3 and the fourth reflected light L4 in FIG. 7(C)) becomes the same angle as the reflection angle θo of the outgoing reflection surface SO. The arrangement as described above leads the entirety of the fourth reflected light L4 to be reflected toward the outgoing reflection surface SO.

In addition, the movable reflection part MR is provided so that the third reflection surface SR3 and and the fourth reflection surface SR4 can be approximated and separated with respect to the first reflection part R1 with being maintained in the above state. Specifically, the movable reflection part MR is provided so that the third reflection surface SR3 and the fourth reflection surface SR4 can be moved in a direction parallel to the symmetry plane SP (right and left direction for FIG. 6 and FIG. 7) with being maintained in the above state. That is, the movable reflection part MR is provided so that, even when the movable reflection part MR is moved, a state is maintained where, when viewed from the normal direction of the symmetry plane SP, the optical axis of the incident light LI incident on the third reflection surface SR3 is always in alignment with the optical axis of the incident light LI incident on the first reflection surface SR1 and the optical axis of the fourth reflected light L4 incident on the outgoing reflection surface SO is also always in alignment with the optical axis of the second reflected light L2 incident on the outgoing reflection surface SO (see FIG. 7(C)).

Moreover, the movable reflection part MR is provided adjacently to the fixed reflection part FR so as to form almost no gap between the end edge of the first reflection surface SR1 on the third reflection surface SR3 side (end edge in the downward direction for FIG. 6(B) and FIG. 7(B)) and the end edge of the third reflection surface SR3 on the first reflection surface SR1 side (end edge in the upward direction for FIG. 6(B) and FIG. 7(B)), and between the end edge of the second reflection surface SR2 on the fourth reflection surface SR4 side and the end edge of the fourth reflection surface SR4 on the second reflection surface SR2 side. For example, although the above gap is desirably not formed, the movable reflection part MR is provided alongside the fixed reflection part FR so that the gap, if any, is formed to be 0.2 mm or less, preferably 0.1 mm or less.

Since the interfering light formation mechanism MA of the second embodiment has the above configuration, it is possible to form an interference image by the interfering reflected light RF using the entirety of the supplied light L. As a result, even if the intensity of the supplied light L is weak, it is possible to form an interference image that can form an interferogram with some degree of signal intensity.

Furthermore, in the interfering light formation mechanism MA of the second embodiment, the entirety of the supplied light L is made incident on one first reflection surface SR1 of the first reflection part R1, and the entirety of the incident light RL reflected at the first reflection surface SR1 can be supplied to the second reflection part R2. Moreover, the incident light RL is reflected at the first to fourth reflection surfaces SR1 to SR4 of the second reflection part R2 with almost no loss and then made incident on the outgoing reflection surface SO as the second reflected light L2 and the fourth reflected light L4. The second reflected light L2 made incident on the outgoing reflection surface SO also produces almost no loss and can be used to form the interference image as the interfering reflected light RF. That is, the interfering light formation mechanism MA of the second embodiment can use the entirety of the supplied light L to form the interference image, which increases the utilization efficiency of the supplied light L.

Furthermore, since the interfering light formation mechanism MA of the second embodiment has the above configuration, all of the reflection angle θi of the incident reflection surface SI, the reflection angles θ1 to θ4 of the first to fourth reflection surfaces SR1 to SR4, and the reflection angle θo of the outgoing reflection surface SO become the same angle, and this relationship does not change even when the movable reflection part MR is moved along the direction parallel to the symmetry plane SP (right and left direction for FIG. 6 and FIG. 7) (see FIG. 7(C)). Therefore, it is possible to change the optical path length with maintaining the optical axis of the supplied light L and the optical axis of the interfering reflected light RF coaxial with each other. Furthermore, even when the movable reflection part MR is moved to change the optical path length, when viewed from the direction parallel to the symmetry plane SP, the optical axes of the incident light LI and L3 incident on the first and third reflection surfaces SR1 and SR3, respectively, are always in alignment, and the optical axes of the second and fourth reflected light L2 and L4 incident on the outgoing reflection surface SO are also always maintained in the aligned state (see FIG. 7(C)). That is, it is possible to change the optical path length of beams of the divided supplied light L in a substantially-common optical path. In other words, it is possible to generate a phase difference in beams of the divided supplied light L in a substantially-common optical path. Therefore, when the movable reflection part MR is moved to change the optical path length, misalignment of the positions where both beams form an image can be prevented, which makes it possible to obtain an interference image having high spatial resolution. Furthermore, the robustness of the interfering light formation mechanism MA against external disturbance such as vibration can be improved.

Note that the optical axis of the interfering reflected light RF means the optical axis of the beams that include both the interfering reflected light RF1, which is the second reflected light L2 reflected at the outgoing reflection surface SO, and the interfering reflected light RF2, which is the fourth reflected light L4 reflected at the outgoing reflection surface SO.

### <Spectroscopic Analysis Device 1A of Second Embodiment>

Next, a spectroscopic analysis device 1A of the second embodiment will be described.

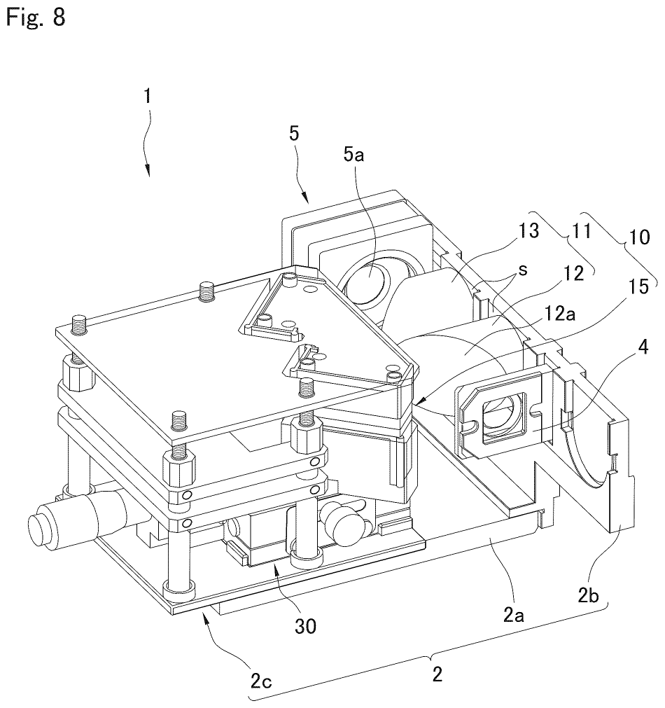

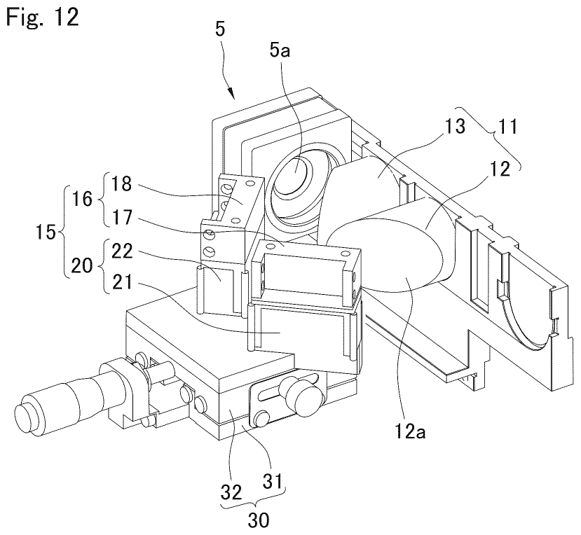

As shown in FIG. 8 to FIG. 12, the spectroscopic analysis device 1A of the second embodiment is a device that discriminates and identifies a substance contained in a measurement target on the basis of light transmitted through gas, liquid, solid, or the like (hereinafter sometimes referred to as “gas or the like”) that is the measurement target or light reflected by the gas or the like (hereinafter sometimes referred to as “object light”). Specifically, the spectroscopic analysis device 1A is a device that performs Fourier transform of an interferogram of an interference image formed from the object light to obtain a spectral characteristic of the object light in order to discriminate and identify a substance contained in the measurement target.

The spectroscopic analysis device 1A of the second embodiment (hereinafter sometimes simply referred to as “spectroscopic analysis device 1A”) has the light supply part 3 (see FIG. 4), a slit 4, the interfering light formation part 10, the detection part 5, and a control part (not shown), the interfering light formation part 10 having a configuration of the interfering light formation mechanism MA of the second embodiment described above.

Hereinafter, description of configurations will be provided. The configurations provided below are examples, and another configuration other than the following configurations may be adopted as long as exerting similar functions.

### <Frame Part 2>

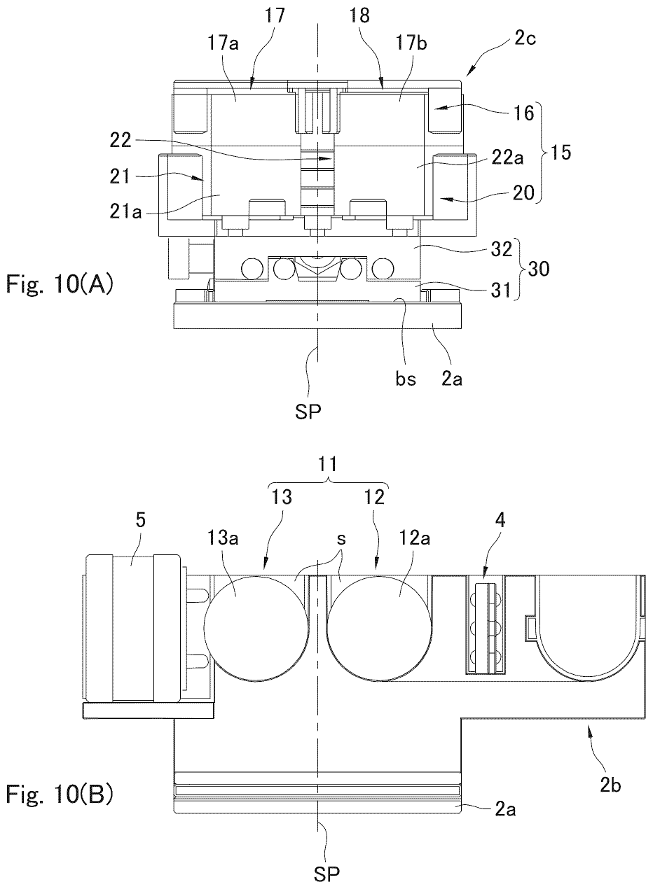

The spectroscopic analysis device 1A includes a frame part 2. The frame part 2 has a base member 2a, a wall member 2b erected on the base member 2a, and a frame body 2c. The base member 2a has a base surface bs (see FIG. 10(A)) having a flat top surface. Note that the base surface bs may be provided on the entire top surface of the base member 2a or only on a part of the top surface of the base member 2a. In the case where the base surface bs is provided only on a part, it is desirable to provide the moving part 30 to be described later on the base surface bs. The wall member 2b is a member in which the light supply part 3, the slit 4, and a first reflection part 11 of the interfering light formation part 10 are installed, and has a surface s provided orthogonal to the base surface bs. Furthermore, the frame body 2c is a member in which a second reflection part 15 of the interfering light formation part 10 is installed.

Note that the structure of the frame part 2 is not limited to the structure described above or the structure shown in FIG. 8.

### <Light Supply Part 3>

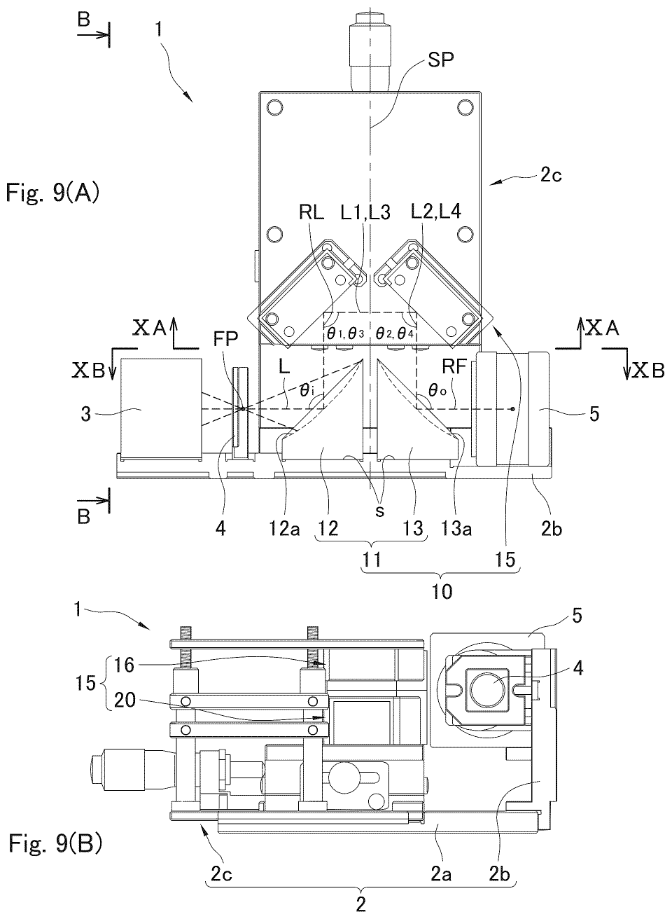

The light supply part 3 supplies the object light to the interfering light formation part 10 as the supplied light L. Specifically, the light supply part 3 collects the object light and then supplies, as the supplied light L, the collected light to an incident reflection surface 12a of the incident member 12 of the interfering light formation part 10. To be more specific, the light supply part 3 has a function of forming the supplied light L so that the optical axis of the supplied light L is positioned on the optical-axis plane parallel to the base surface bs of the base member 2a (corresponding to the plane V for FIG. 6 and FIG. 7) and becomes parallel to the surface s of the wall member 2b. Moreover, the light supply part 3 also has a function of forming a focal point FP (see FIG. 9(A)) between the light supply part 3 and the incident reflection surface 12a of the incident member 12 of the interfering light formation part 10 and then making the supplied light L incident on the incident reflection surface 12a of the incident member 12 of the interfering light formation part 10.

Moreover, the light supply part 3 is provided so that the entirety of the supplied light L is made incident on the incident reflection surface 12a of the incident member 12 of the interfering light formation part 10. In this context, the expression “the entirety of the supplied light L is made incident on the incident reflection surface 12a of the incident member 12 of the interfering light formation part 10” means that, of the supplied light L that has passed through the slit 4 to be described later, the entirety of the supplied light L to be used for forming the interfering reflected light RF is made incident on the incident reflection surface 12a of the incident member 12 of the interfering light formation part 10. Furthermore, the expression “the entirety of the supplied light L is made incident on the incident reflection surface 12a of the incident member 12 of the interfering light formation part 10” includes both of the case where the entirety of the supplied light L that has passed through the slit 4 to be described later is made incident on the incident reflection surface 12a of the incident member 12 of the interfering light formation part 10 and the case where a small part of the supplied light L that has passed through the slit 4 to be described later is not made incident on the incident reflection surface 12a of the incident member 12 but the large part of the supplied light L is made incident on the incident reflection surface 12a of the incident member 12 of the interfering light formation part 10.

Note that, for the light supply part 3, it is possible to use a general objective lens, a parabolic mirror, or the like as a member that forms the supplied light L. However, the member is not particularly limited as long as satisfying the functions described above.

### <Slit 4>

The slit 4 is provided between the light supply part 3 and the incident reflection surface 12a of the incident member 12 of the interfering light formation part 10. The slit 4, which functions as, for example, a deflection filter, is provided at the position of the focal point FP described above.

Note that the slit 4 is not necessarily provided. However, providing the slit 4 enables the interference image to be formed only with light of waves in a specific direction, thereby increasing the accuracy of discriminating and identifying the substance. Furthermore, a pinhole may be provided instead of the slit 4.

### <Interfering Light Formation Part 10>

The interfering light formation part 10 has substantially the same configuration as the interfering light formation mechanism MA described above.

The interfering light formation part 10 has the first reflection part 11, the second reflection part 15, and the moving part 30. The first reflection part 11 and the second reflection part 15 have a function substantially equivalent to that of the first reflection part R1 and the second reflection part R2 of the interfering light formation mechanism MA of the second embodiment described above. In the following, description of portions having the equivalent configuration or equivalent disposition as the interfering light formation mechanism MA of the second embodiment will be omitted as appropriate.

### <First Reflection Part 11>

As shown in FIG. 8 and FIGS. 9, on the surface s of the wall member 2b, the incident member 12 of the first reflection part 11 is provided. The incident member 12 includes the incident reflection surface 12a that allows the supplied light L supplied from the light supply part 3 and passed through the slit 4 to be incident thereon. The incident reflection surface 12a is a parabolic surface, and is provided so as to convert the supplied light L into the incident light LI that is parallel light to reflect the converted light toward the second reflection part 15. Moreover, the incident member 12 is provided so as to reflect the supplied light L to make the optical axis of the incident light RL be positioned on the optical-axis plane described above (see FIG. 9(A)).

Furthermore, on the surface s of the wall member 2b, an outgoing member 13 of the first reflection part 11 is provided. The outgoing member 13 has an outgoing reflection surface 13a that allows the reflected light (the second and fourth reflected light L2 and L4 described above) supplied from the second reflection part 15 to be incident thereon, and is arranged so that the outgoing reflection surface 13a becomes plane-symmetrical with the incident reflection surface 12a of the incident member 12 with respect to the symmetry plane SP orthogonal to the optical axis of the supplied light L. The outgoing reflection surface 13a is a parabolic surface, and is provided so as to reflect the reflected light toward the detection part 5 to be described later as the interfering reflected light RF.

Note that, in the above configuration, in the first reflection part 11, the incident member 12 described above corresponds to the incident part in claim 6, and the outgoing member 13 described above corresponds to the outgoing part in claim 6.

### <Second Reflection Part 15>

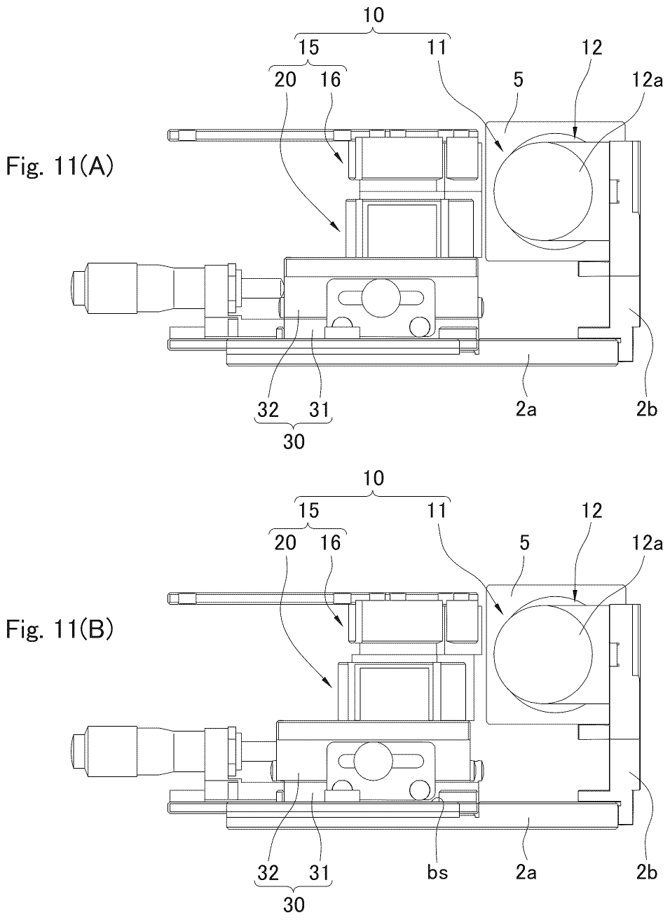

As shown in FIG. 9 and FIGS. 11, the second reflection part 15 is provided on the lateral side of the first reflection part 11 so as to face the incident reflection surface 12a of the incident member 12 and the outgoing reflection surface 13a of the outgoing member 13 of the first reflection part 11. The second reflection part 15 has the fixed reflection part 16 and the movable reflection part 20.

### <Fixed Reflection Part 16>

As shown in FIG. 10(A), the fixed reflection part 16 has a first mirror 17 and a second mirror 18 fixed to the frame body 2c of the frame part 2. The first mirror 17 and the second mirror 18 have a reflection surface 17a and a reflection surface 18a, respectively, which are flat surfaces, and the reflection surface 17a and the reflection surface 18a are provided so as to face the incident reflection surface 12a of the incident member 12 and the outgoing reflection surface 13a of the outgoing member 13, respectively (see FIG. 9(A)). Moreover, the first mirror 17 and the second mirror 18 are arranged so that the reflection surfaces 17a of the first mirror 17 and the reflection surface 18a of the second mirror 18 are mutually plane-symmetrical with respect to the symmetry plane SP.

Furthermore, the first mirror 17 is provided so that the reflection angle θ1 of the reflection surface 17a and the reflection angle θi of the incident reflection surface 12a of the incident member 12 of the first reflection part 11 become the same angle and, additionally, the optical axis of the first reflected light L1 becomes parallel to the optical-axis plane (see FIG. 7 and FIG. 9(A)).

On the other hand, the second mirror 18 is provided so that the reflection angle θ2 of the reflection surface 18a and the reflection angle θo of the outgoing reflection surface 13a of the outgoing member 13 of the first reflection part 11 become the same angle and, additionally, the optical axis of the second reflected light L2 becomes parallel to the optical-axis plane (see FIG. 7 and FIG. 9(A)).

### <Movable Reflection Part 20>

As shown in FIG. 10 to FIGS. 11, the movable reflection part 20 is fixed to a movable table 32 of the moving part 30 installed on the base surface bs of the base member 2a of the frame part 2. Similarly to the first mirror 17 and the second mirror 18, the third mirror 21 and the fourth mirror 22 are provided so that the reflection surfaces 21a and 22a thereof face the incident reflection surface 12a of the incident member 12 and the outgoing reflection surface 13a of the outgoing member 13, respectively. Moreover, the third mirror 21 and the fourth mirror 22 are arranged so that the reflection surface 21a of the third mirror 21 and the reflection surface 22a of the fourth mirror 22 are mutually plane-symmetrical with respect to the symmetry plane SP.

Furthermore, the third mirror 21 is provided so that the reflection angle θ3 of the reflection surface 21a and the reflection angle θi of the incident reflection surface 12a of the incident member 12 of the first reflection part 11 become the same angle and, additionally, the optical axis of the third reflected light L3 becomes parallel to the optical-axis plane (see FIG. 7 and FIG. 9(A)).

On the other hand, the fourth mirror 22 is provided so that the reflection angle θ4 of the reflection surface 22a and the reflection angle θo of the outgoing reflection surface 13a of the outgoing member 13 of the first reflection part 11 become the same angle and, additionally, the optical axis of the fourth reflected light L4 becomes parallel to the optical-axis plane (see FIG. 7 and FIG. 9(A)).

Moreover, the movable reflection part 20 is provided adjacently to the fixed reflection part 16 so as to form almost no gap between the end edge of the first mirror 17 of the fixed reflection part 16 on the third mirror 21 side (end edge in the downward direction for FIG. 10(A)) and the end edge of the third mirror 21 on the first mirror 17 side (end edge in the upward direction for FIG. 10(A)), and between the end edge of the second mirror 18 of the fixed reflection part 16 on the fourth mirror 22 side and the end edge of the fourth mirror 22 on the second mirror 18 side. For example, although the above gap is desirably not formed, the movable reflection part 20 is provided alongside the fixed reflection part 16 so that the gap, if any, is formed to be 0.2 mm or less, preferably 0.1 mm or less.

### <Moving Part 30>

The moving part 30 is provided on the base surface bs of the base member 2a of the frame part 2 as described above. The moving part 30 has a base part 31, the movable table 32 that is provided to be movable in one direction (right and left direction in FIG. 11) with respect to the base part 31, and a moving mechanism that moves the movable table 32. Furthermore, the moving part 30 is provided so that the movement direction of the movable table 32 becomes parallel to the symmetry plane SP and the base surface bs of the base member 2a. Therefore, when the movable table 32 is moved by the moving mechanism, the movable reflection part 20 (i.e., the third mirror 21 and the fourth mirror 22 of the movable reflection part 20) can be approximated and separated with respect to the first reflection part 11 while maintaining the relationship described above.

Therefore, when the supplied light L is made incident on the interfering light formation part 10, the supplied light L is reflected at the incident reflection surface 12a of the incident member 12 to become the incident light RL, and the incident light RL is made incident on the first mirror 17 of the fixed reflection part 16 of the second reflection part 15 and the third mirror 21 of the movable reflection part 20. The incident light LI is reflected at the reflection surface 17a of the first mirror 17 and the reflection surface 18a of the second mirror 18 to become the first reflected light L1 and the third reflected light L3, and the first reflected light L1 and the third reflected light L3 are made incident on the second mirror 18 of the fixed reflection part 16 and the fourth mirror 22 of the movable reflection part 20, respectively. The first reflected light L1 and the third reflected light L3 are reflected at the reflection surface 18a of the second mirror 18 and the reflection surface 22a of the third mirror 22, respectively to become the second reflected light L2 and the fourth reflected light L4, and the second reflected light L2 and the fourth reflected light L4 are made incident on the outgoing reflection surface 13a of the outgoing member 13. Then, the second reflected light L2 and the fourth reflected light L4 are reflected at the outgoing reflection surface 13a of the outgoing member 13 and emitted from the interfering light formation part 10 as the interfering reflected light RF, which is a combination of the interfering reflected light RF1 and RF2. At this time, since the optical axis of the suppled light L and the optical axis of the interfering reflected light RF are coaxial, and the optical axes of the first to fourth reflected light L1 to L4 are all parallel to the optical-axis plane, the interfering reflected light RF1 and RF2 form focal points at the same position at a predetermined distance from the outgoing reflection surface 13a of the outgoing member 13. That is, the focal points of the interfering reflected light RF1 and RF2 match each other, and interference images can be formed at this focal point.

Furthermore, when the movable table 32 of the moving part 30 is moved, it is possible to generate an optical path difference between the optical path of a first interfering reflected light beam (beams constituted by the incident light RL, the first reflected light L1, the second reflected light L2, and the interfering reflected light RF1) and the optical path of a second interfering reflected light beam (beams constituted by the incident light RL, the third reflected light L2, the fourth reflected light L4, and the interfering reflected light RF2). Moreover, it is possible to generate a phase difference in substantially-common optical paths (specifically, substantially-common optical paths when viewed from the normal direction of the optical-axis plane), and therefore it is also possible to prevent misalignment of the positions where both beams form an image when the optical path length is changed by moving the movable reflection part 20.

Note that the moving part 30 is not particularly limited as long as having a function of accurately moving the movable table 32 in one direction at constant velocity (for example, 30 μm/s or less). For example, a commercially-available uniaxial stage or the like can be used as the moving part 30.

Furthermore, the movable table 32 may be configured to be manually or automatically moved. Note that, in the case where the movable table 32 is configured to be automatically moved, it becomes easy to accurately adjust the optical path difference. Furthermore, an advantage of being able to move the movable reflection part 20 at constant velocity can be obtained.

### <Detection Part 5>

The detection part 5 has a function of measuring the light intensity of the interfering reflected light RF supplied from the outgoing reflection surface 13 of the interfering light formation part 10. Specifically, the detection part 5 has the detection surface 5a provided with light-receiving elements, and the detection part 5 is arranged so as to form an interference image on the detection surface 5a. That is, the detection part 5 can have a function of measuring the light intensity of interference fringes formed on the detection surface 5a. In addition, the detection part 5 has a function of supplying a signal related to the light intensity detected by the light-receiving elements of the detection surface 5a (light intensity of the interference fringes) to the control part.

The detection part 5 is not particularly limited as long as having the functions described above, and a two-dimensional CCD camera, a CMOS camera, or the like may be employed. Like the two-dimensional CCD camera, by using the detection part 5 with the detection surface 5a having a plurality of light-receiving elements arrayed two-dimensionally, it is possible to obtain two-dimensional distribution of the substance in the measurement target. For example, in the measurement target, it is also possible to two-dimensionally acquire the presence position of the substance or acquire two-dimensional distribution of concentration or the like.

### <Control Part>

The control part has an analysis function of analyzing a signal related to the light intensity of the interference image detected by the detection part 5. Specifically, the control part has a function of analyzing the optical path length difference between the interfering reflected light RF1 and RF2 and a signal related to the light intensity supplied from the detection part 5 to form an interferogram, and performing Fourier transform of the interferogram to acquire a spectral characteristic.

Note that, in the case where the moving mechanism of the moving part 30 is configured to automatically move the movable table 32, the control part may have a function of controlling operation of the moving mechanism. With such function, it is possible to match the movement of the movable table 32, i.e., movement of the third mirror 21 and the fourth mirror 22 of the movable reflection part 20 with a frame rate of the camera. That is, since the light intensity can be acquired at equal intervals, Fourier transform of the interferogram formed on the basis of the acquired light intensity is facilitated. As a result, signal processing to acquire the spectral characteristic can be facilitated and data processing time can be shortened.

Since the spectroscopic analysis device 1A of the second embodiment has the configuration as described above, making the object light incident on the interfering light formation part 10 through the light supply part 3 enables formation of an interference image on the detection surface 5a of the detection part 5. As a result, by analyzing the interference image with the control part, it is possible to discriminate and identify the substance contained in the measurement target.

Moreover, since it is possible to use nearly entirety of the object light supplied through the light supply part 3 to form an interference image, the utilization efficiency of the supplied light L can be increased and the accuracy of discriminating and identifying the substance contained in the measurement target can be increased.

Note that the spectroscopic analysis device 1A of the second embodiment is not necessarily provided with the control part. In such case, a function of storing the signals related to the light intensity supplied to the control part and the optical path length difference between the interfering reflected light RF1 and RF2 as measurement data may be provided, and the measurement data may be analyzed by another analysis device.

### <Interfering Light Formation Mechanism MB of Third Embodiment>

Regarding the spectroscopic analysis device 1A of the second embodiment, the case has been described as above where the incident reflection surface 12a of the incident member 12 of the incident part of the first reflection part 11 and the outgoing reflection surface 13a of the outgoing member 13 are parabolic surfaces. However, the incident reflection surface 12a of the incident member 12 of the first reflection part 11 and the outgoing reflection surface 13a of the outgoing member 13 may be flat surfaces. That is, as the configuration of the interfering light formation mechanism to be employed in the spectroscopic analysis device 1A of the second embodiment, it is possible to employ an interfering light formation mechanism MB (interfering light formation mechanism MB of a third embodiment) in which the incident reflection surface SI and the outgoing reflection surface SO of the first reflection part R1 are flat surfaces.

Hereinafter, description will be made on the interfering light formation mechanism MB of the third embodiment in which the incident reflection surface SI and the outgoing reflection surface SO of the first reflection part R1 are flat surfaces.

As shown in FIG. 9 and FIGS. 10, the interfering light formation mechanism MB of the third embodiment (hereinafter sometimes simply referred to as “interfering light formation mechanism MB”) has the first reflection part R1 and the second reflection part R2.

### <First Reflection Part R1>

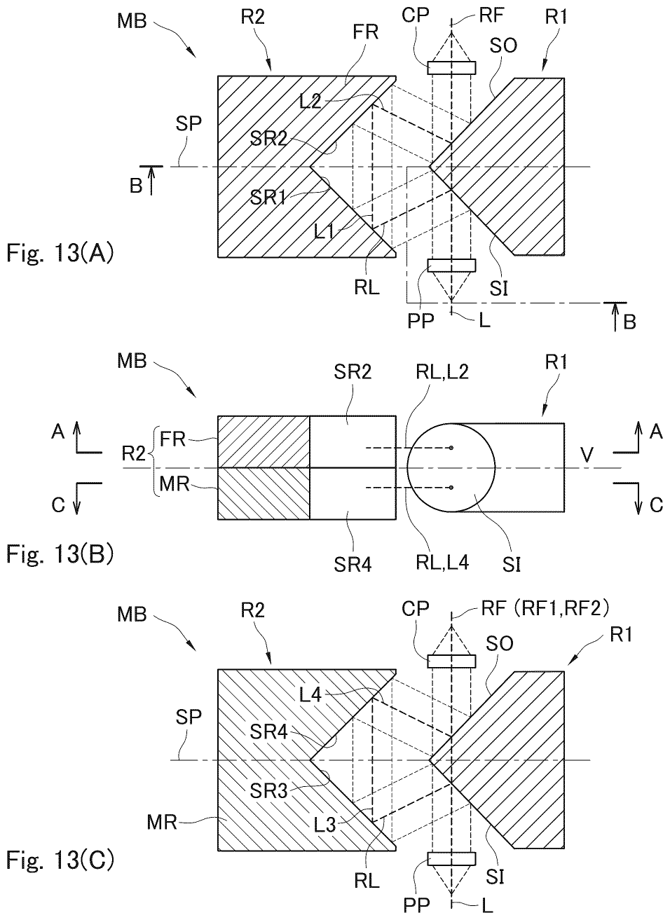

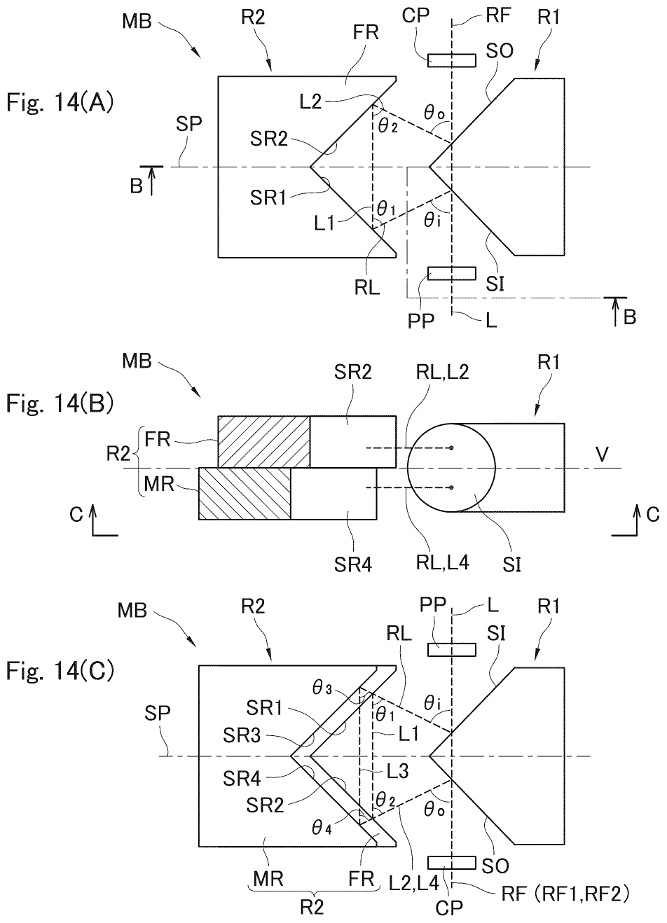

As shown in FIG. 13 and FIGS. 14, the first reflection part R1 includes the incident reflection surface SI and the outgoing reflection surface SO provided so as to be mutually plane-symmetrical with respect to the symmetry plane SP. Both the incident reflection surface SI and the outgoing reflection surface SO are formed as flat surfaces.

The first reflection part R1 has a parallel light formation part PP at a position facing the incident reflection surface SI. The parallel light formation part PP is, for example, a collecting lens or the like, and supplies the supplied light L made incident on the incident reflection surface SI as parallel light to the incident reflection surface SI.

Furthermore, the first reflection part R1 includes a light collection part CP at a position facing the outgoing reflection surface SO. The light collection part CP is, for example, a collecting lens or the like, and collects the interfering reflected light RF that is parallel light reflected at the outgoing reflection surface SO.

Note that, in the above configuration, in the first reflection part R1, a portion where the incident reflection surface SI described above is provided and the parallel light formation part PP correspond to the incident part in claim 6 of CLAIMS, and a portion where the outgoing reflection surface SO described above is provided and the light collection part CP correspond to the outgoing part in claim 6 of CLAIMS.

### <Second Reflection Part R2>

As shown in FIG. 13 and FIGS. 14, the second reflection part R2 is provided so as to face the incident reflection surface SI and the outgoing reflection surface SO of the first reflection part R1. The second reflection part R2 has a fixed reflection part FR whose movement is fixed with respect to the first reflection part R1, and the movable reflection part MR provided to be movable with respect to the first reflection part R1 (see FIG. 13(B) and FIG. 14(B)).

### <Fixed Reflection Part FR>

As shown in FIG. 13 and FIGS. 14, the fixed reflection part FR includes the first reflection surface SR1 and the second reflection surface SR2 provided plane-symmetrically with respect to the symmetry plane SP.

The first reflection surface SR1 is provided so as to face the incident reflection surface SI of the first reflection part R1. Specifically, the first reflection surface SR1 is provided so as to allow, when light parallel to the normal of the symmetry plane SP (hereinafter referred to as “supplied light L”) is made incident on the incident reflection surface SI of the first reflection part R1, a part of the reflected light of the incident light (hereinafter referred to as “incident light RL”) (for FIG. 13(B) and FIG. 14(B), light reflected at the upper portion (portion above the plane V by which the incident reflection surface SI is divided into two portions upward and downward) of the incident reflection surface SI) to be incident thereon. Moreover, the first reflection surface SR1 is provided so that the optical axis of the reflected light that has reflected the incident light RL (hereinafter referred to as “first reflected light L1”) becomes parallel to the normal of the symmetry plane SP (in other words, the optical axis of the supplied light L). That is, the first reflection surface SR1 is provided so that the reflection angle θ1 thereof (angle θ1 formed between the incident light RL and the first reflected light L1 in FIG. 14(A)) becomes the same angle as the reflection angle θi of the incident reflection surface SI (angle θi formed between the supplied light L and the incident light RL in FIG. 14(A)). Note that the arrangement as described above leads the entirety of the first reflected light L1 to be reflected toward the second reflection surface SR2.

The second reflection surface SR2 is provided so as to face the outgoing reflection surface SO of the first reflection part R1. Specifically, the second reflection surface SR2 is provided so that, when the first reflected light L1 made incident from the first reflection surface SR1 is reflected by the second reflection surface SR2, the reflected light (hereinafter referred to as “second reflected light L2”) becomes incident on the outgoing reflection surface SO (specifically, the upper portion of the outgoing reflection surface SO). Moreover, the second reflection surface SR2 is provided so that the angle formed between the optical axis of the second reflected light L2 and the symmetry plane SP becomes the same angle as the angle formed between the optical axis of the incident light LI and the symmetry plane SP. The arrangement as described above leads the entirety of the second reflected light L2 to be reflected toward the outgoing reflection surface SO.

In this situation, since the second reflection surface SR2 is provided plane-symmetrically with the first reflection surface SR1 with respect to the symmetry plane SP, with the above configuration, the reflection angle θo of the outgoing reflection surface SO (angle θo formed between the second reflected light L2 and the light reflected at the outgoing reflection surface SO in FIG. 14(A) (hereinafter referred to as “interfering reflected light RF”)) becomes the same as the reflection angle θi of the incident reflection surface SI. Therefore, if the second reflection surface SR2 is provided as described above, the reflection angle θ2 of the second reflection surface SR2 (angle θ2 formed between the first reflected light L1 and the second reflected light L2 in FIG. 14(A)) becomes the same angle as the reflection angle θo of the outgoing reflection surface SO.

### <Movable Reflection Part MR>

As shown in FIG. 13(C) and FIG. 14(C), the movable reflection part MR has the third reflection surface SR3 and the fourth reflection surface SR4 provided plane-symmetrically with respect to the symmetry plane SP.

The third reflection surface SR3, which is a surface provided in parallel to the first reflection surface SR1, is provided so as to have a positional relationship to the incident reflection surface SI substantially similar to the positional relationship of the first reflection surface SR1. That is, the third reflection surface SR3 is provided so as to allow, when the supplied light L is made incident on the incident reflection surface SI of the first reflection part R1, a part of the incident light RL (for FIG. 13(B) and FIG. 14(B), light reflected at the lower portion (portion below the plane V) of the incident reflection surface SI) to be incident thereon. Moreover, the third reflection surface SR3 is provided so that the optical axis of the reflected light that has reflected the incident light RL (hereinafter referred to as “third reflected light L3”) becomes parallel to the normal of the symmetry plane SP (in other words, the optical axis of the supplied light L). That is, the third reflection surface SR3 is provided so that the reflection angle θ3 thereof (angle θ3 formed between the incident light RL and the third reflected light L3 in FIG. 14(C)) becomes the same angle as the reflection angle θi of the incident reflection surface SI. Note that the arrangement as described above leads the entirety of the third reflected light L3 to be reflected toward the fourth reflection surface SR4.

The fourth reflection surface SR4, which is a surface provided in parallel to the second reflection surface SR2, is provided so as to have a positional relationship to the outgoing reflection surface SO substantially similar to the positional relationship of the second reflection surface SR2. That is, the fourth reflection surface SR4 is provided so that, when the third reflected light L3 made incident from the third reflection surface SR3 is reflected by the fourth reflection surface SR4, the reflected light (hereinafter referred to as “fourth reflected light L4”) becomes incident on the outgoing reflection surface SO (specifically, the lower portion of the outgoing reflection surface SO). Moreover, the fourth reflection surface SR4 is provided so that the angle formed between the optical axis of the fourth reflected light L4 and the symmetry plane SP becomes the same angle as the angle formed between the optical axis of the incident light LI and the symmetry plane SP. That is, the fourth reflection surface SR4 is provided so that the reflection angle θ4 thereof (angle θ4 formed between the third reflected light L3 and the fourth reflected light L4 in FIG. 14(C)) becomes the same angle as the reflection angle θo of the outgoing reflection surface SO. The arrangement as described above leads the entirety of the fourth reflected light L4 to be reflected toward the outgoing reflection surface SO.

In addition, the movable reflection part MR is provided so that the third reflection surface SR3 and and the fourth reflection surface SR4 can be approximated and separated with respect to the first reflection part R1 with being maintained in the above state. Specifically, the movable reflection part MR is provided so that the third reflection surface SR3 and the fourth reflection surface SR4 can be moved in a direction parallel to the symmetry plane SP (right and left direction in FIG. 13 and FIG. 14) with being maintained in the above state. That is, the movable reflection part MR is provided so that a state is maintained where, when viewed from the normal direction of the symmetry plane SP, the optical axis of the incident light LI incident on the third reflection surface SR3 is always in alignment with the optical axis of the incident light LI incident on the first reflection surface SR1 and the optical axis of the fourth reflected light L4 incident on the outgoing reflection surface SO is also always in alignment with the optical axis of the second reflected light L2 incident on the outgoing reflection surface SO (see FIG. 13(C)).

Moreover, the movable reflection part MR is provided adjacently to the fixed reflection part FR so as to form almost no gap between the end edge of the first reflection surface SR1 on the third reflection surface SR3 side (end edge in the downward direction for FIG. 13(B) and FIG. 14(B)) and the end edge of the third reflection surface SR3 on the first reflection surface SR1 side (end edge in the upward direction for FIG. 13(B) and FIG. 14(B)), and between the end edge of the second reflection surface SR2 on the fourth reflection surface SR4 side and the end edge of the fourth reflection surface SR4 on the second reflection surface SR2 side. For example, although the above gap is desirably not formed, the movable reflection part MR is provided alongside the fixed reflection part FR so that the gap, if any, is formed to be 0.2 mm or less, preferably 0.1 mm or less.

Since the interfering light formation mechanism MB of the third embodiment has the above configuration, it is possible to form an interference image by the interfering reflected light RF using the entirety of the supplied light L. As a result, even if the intensity of the supplied light L is weak, it is possible to form an interference image that can form an interferogram with some degree of signal intensity.

Furthermore, since the interfering light formation mechanism MB of the third embodiment has the above configuration, all of the reflection angle θi of the incident reflection surface SI, the reflection angles θ1 to θ4 of the first to fourth reflection surfaces SR1 to SR4, and the reflection angle θo of the outgoing reflection surface SO become the same angle, and this relationship does not change even when the movable reflection part MR is moved (see FIG. 14(C)). Therefore, it is possible to change the optical path length with maintaining the optical axis of the supplied light L and the optical axis of the interfering reflected light RF coaxial with each other. Furthermore, even when the movable reflection part MR is moved to change the optical path length, when viewed from the normal direction of the symmetry plane SP, the optical axes of the incident light LI and L3 incident on the first and third reflection surfaces SR1 and SR3, respectively, are always in alignment, and the optical axes of the second and fourth reflected light L2 and L4 incident on the outgoing reflection surface SO are also always maintained in the aligned state (see FIG. 14(C)). That is, it is possible to change the optical path length of beams of the divided supplied light L in a substantially-common optical path, in other words, to generate a phase difference in beams of the divided supplied light L in a substantially-common optical path. Therefore, when the movable reflection part MR is moved to change the optical path length, misalignment of the positions where both beams form an image can be prevented, which makes it possible to obtain an interference image having high spatial resolution. Furthermore, the robustness of the interfering light formation mechanism MB against external disturbance such as vibration can be improved.

Note that the optical axis of the interfering reflected light RF means the optical axis of the beams that include both the interfering reflected light RF1, which is the second reflected light L2 reflected at the outgoing reflection surface SO, and the interfering reflected light RF2, which is the fourth reflected light L4 reflected at the outgoing reflection surface SO.

### <Notes on Outgoing Reflection Surface SO>

As described above, regarding the interfering light formation mechanism MB, description has been made on the case where both the incident reflection surface SI and the outgoing reflection surface SO of the first reflection part R1 are flat surfaces. However, also in the case where the incident reflection surface S of the first reflection part R1 is formed as a flat surface, the outgoing reflection surface SO may be formed as a parabolic surface. In such case, need to provide the light collection part CP is eliminated.

Note that, in the case where the outgoing reflection surface SO is formed as a parabolic surface, the incident reflection surface SI of the first reflection part R1 is not plane-symmetrical with the outgoing reflection surface SO. However, if the reflection angle θo of the outgoing reflection surface SO is provided so as to form the same angle as the reflection angle θi of the incident reflection surface SI, it is possible to obtain the interfering reflected light RF whose optical axis is the same as the case where both the incident reflection surface SI and the outgoing reflection surfaces SO of the first reflection part R1 are formed as flat surfaces.

### EXAMPLES

### Example 1

It was confirmed that use of the spectroscopic analysis device having the above-described functions of the present invention enables prevention of misalignment of the image-formation positions of the first interfering reflected light beam and the second interfering reflected light beam even when the optical path length is changed.

In an experiment, a laser beam having a wavelength of 635 nm was made incident from a small laser-beam source (CMP-635-1-D) in the spectroscopic analysis device to change the optical path length, and the interference image formed on the detection part (CMOS camera) was confirmed.

Note that, in the experiment, the spectroscopic analysis device having the structure shown in FIG. 8 to FIG. 12 was used. Members used in this spectroscopic analysis device are as follows.
Incident member and outgoing member: parabolic mirror (Model: 87-406 manufactured by Edmont Optics)
Moving part: manual stage (High Grade Stage LS-5042-C8 manufactured by Chuo Precision Industrial)

Note that the reflection angles θi of the parabolic surfaces of the incident member and the outgoing member (i.e., reflection angles θ1 to θ4 of the first to fourth mirrors (see FIG. 7)) are 90 degrees.

The third mirror and the fourth mirror of the movable reflection part were manually moved by a micro gauge provided in the moving part.

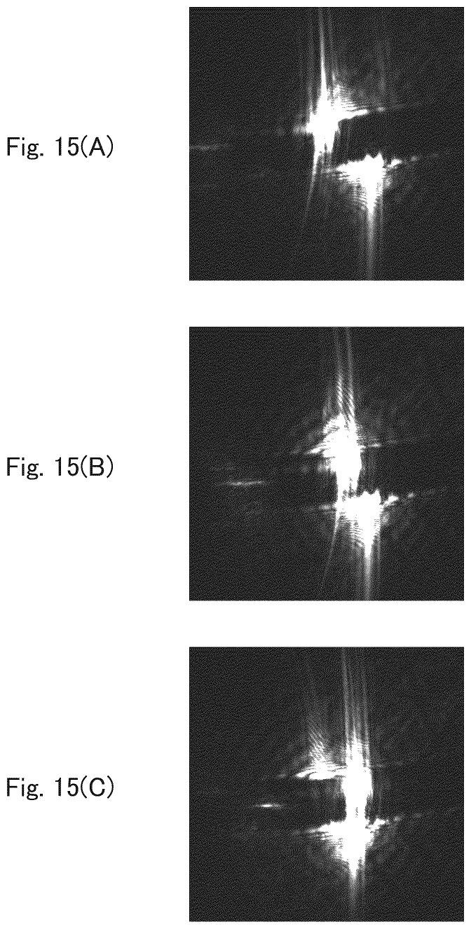

Results are shown in FIG. 15.

In FIGS. 15, FIG. 15(A) shows an interference image in a state where the first mirror (second mirror) and the third mirror (fourth mirror) are flush with each other, FIG. 15(B) shows an interference image in a state where the first mirror (second mirror) and the third mirror (fourth mirror) are approximated to the incident member and the outgoing member from the state of FIG. 15(A), and FIG. 15(C) shows an interference image in a state where the first mirror (second mirror) and the third mirror (fourth mirror) are separated from the incident member and the outgoing member from the state of FIG. 15(A). As shown in FIG. 8, it was confirmed that movement of the third mirror (fourth mirror) did not cause misalignment of positions of the interference image.

### Example 2

It was confirmed that the spectroscopic analysis device having the above-described functions of the present invention can two-dimensionally form an interference image of gas.

For the experiment, the spectroscopic analysis device having the configuration as shown in FIG. 3 and FIG. 4 was used and a CMOS camera was used as the detection part. The spectroscopic analysis device employs, as a moving part, a manual stage (High Grade Stage LS-5042-C8 manufactured by Chuo Precision Industrial), and the movable reflection part is installed on the manual stage.

In the experiment, a black body (whose temperature is 160° C.) was installed at a position 160 mm distant from the spectroscopic analysis device, to bring a state of photographing the black body by the CMOS camera of the spectroscopic analysis device. In this state, gas was injected into the space between the black body and the spectroscopic analysis device, and the interference image of the object light obtained from the gas was photographed. Then, the photographed interference image was analyzed to form an interferogram at pixels of the CMOS camera, and the interferogram was used to form a visualized image of the gas.

Note that the gas used was dimethyl ether (DME), and the temperature during the experiment was 20° C. Furthermore, the optical path length difference between the interfering reflected light RFA and LFB was changed by moving the manual stage by manually operating the micro gauge.

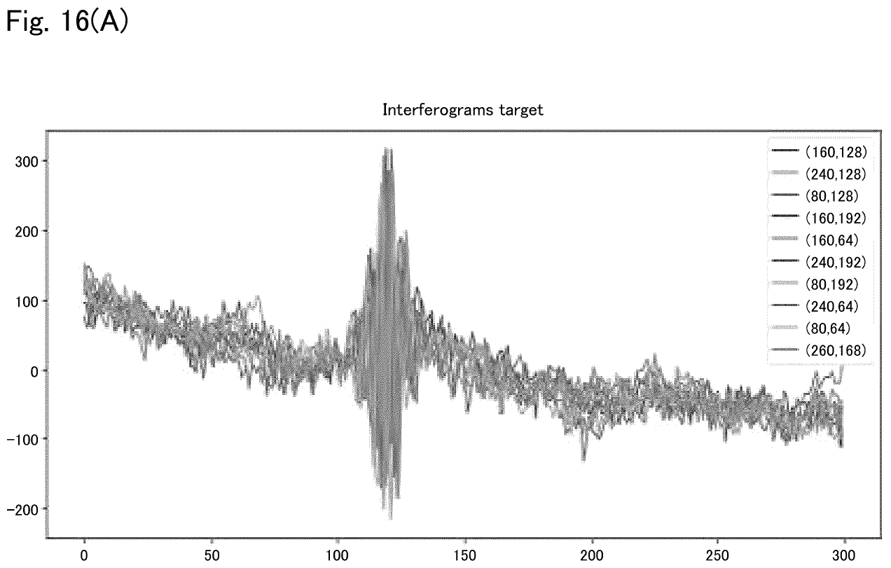

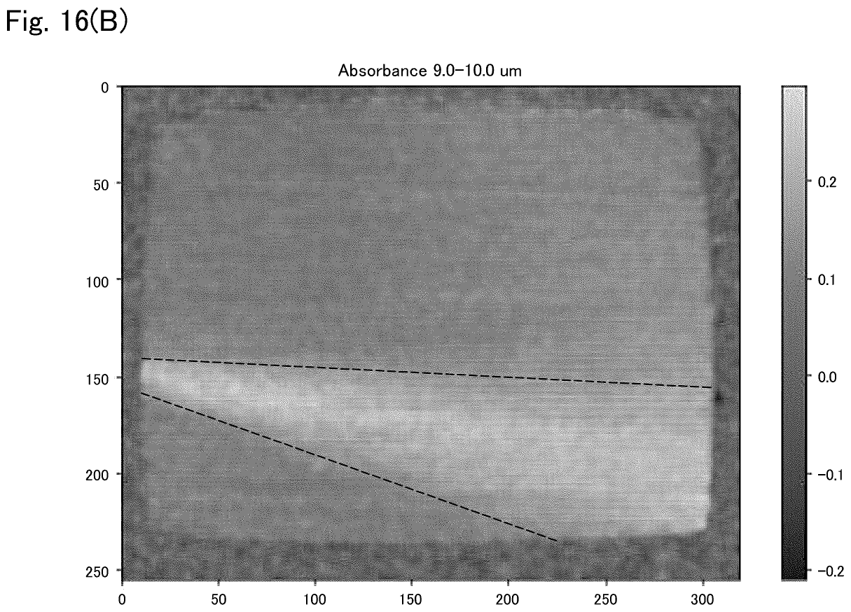

Results are shown in FIG. 16.

As shown in FIG. 16(A), it was confirmed that, by using the spectroscopic analysis device of the present invention, an accurate interferogram can be obtained from the detected signal of pixels of the CMOS camera. That is, it was confirmed that change in the optical path length of the interfering reflected light RFA and the optical path length of the interfering reflected light RFB did not cause misalignment of positions of the interference image formed from each interfering light within the plane.

Furthermore, as shown in FIG. 16(B), it was confirmed that, use of the spectroscopic analysis device of the present invention leads to formation of a clear two-dimensional visible image of the gas by using an interferogram formed from the detection signal of pixels.

From the above results, it was confirmed that the spectroscopic analysis device of the present invention can form an accurate interferogram at each position within the two-dimensional plane and can form a clear two-dimensional visible image of the gas, because misalignment of the positions of the interference images is not caused even when the optical path length of the interfering reflected light RFA and the optical path length of the interfering reflected light RFB change.

### INDUSTRIAL APPLICABILITY

The spectroscopic analysis device of the present invention is suitable for a system that visualizes gas or detects and analyzes gas.

### REFERENCE SIGNS LIST

1 Spectroscopic analysis device
2 Frame
3 Light supply part
3a Supply part
4 Diffraction grating
5 Detection part
7 Control part
10 Interfering light formation part
11 First reflection part
12 Incident member
12a Incident reflection surface
13 Outgoing member
13a Outgoing reflection surface
15 Second reflection part
16 Fixed reflection part
17 First mirror
17a First reflection surface
18 Second mirror
18a Second reflection surface
20 Movable reflection part
21 Third mirror
21a Third reflection surface
22 Fourth mirror
22a Fourth reflection surface
25 Incident parallel light formation part
28 Light collection part
29 Light-traveling direction change member
30 Moving part
M Interfering light formation mechanism
FR Fixed reflection part
SR1 First reflection surface
SR2 Second reflection surface
MR Movable reflection part
SR3 Third reflection surface
SR4 Fourth reflection surface
L Supplied light
LA Supplied light
LB Supplied light
RA Reflected light
RB Reflected light
LF Interfering reflected light
LFA Interfering reflected light
LFB Interfering reflected light
BP Base plane
R1 First reflection part
SI Incident reflection surface
SO Outgoing reflection surface
PP Parallel light formation part
CP Light Collection part
R2 Second reflection part
SI Incident reflection surface
SO Outgoing reflection surface
θi Reflection angle
θo Reflection angle
θ1 Reflection angle
θ2 Reflection angle
θ3 Reflection angle
θ4 Reflection angle
RL Incident light
L2 Second reflected light
L3 Third reflected light
L4 Fourth reflected light
L4 Fourth reflected light
LF Interfering reflected light
SP Symmetry plane

1. A spectroscopic analysis device comprising:
a light supply part;
an interfering light formation part that forms interfering light from supplied light supplied from the light supply part; and
a detection part that detects light intensity of the interfering light formed by the interfering light formation part, wherein
the interfering light formation part includes
a fixed reflection part whose movement is fixed,
a movable reflection part provided to be movable along a base plane parallel to an optical axis of the supplied light supplied from the light supply part, and
a moving part that moves and fixes the movable reflection part along the base plane,
the fixed reflection part includes
a first reflection surface that reflects the supplied light supplied from the light supply part and
a second reflection surface provided to be plane-symmetrical with the first reflection surface with respect to the base plane and to be orthogonal to the first reflection surface, and
the movable reflection part includes
a third reflection surface and a fourth reflection surface parallel to the first reflection surface and the second reflection surface of the fixed reflection part, respectively.

2. The spectroscopic analysis device according to claim 1, wherein
the interfering light formation part includes:
an incident parallel light formation part that collimates the supplied light supplied from the light supply part as parallel light; and/or
a light collection part that collects light reflected at the second reflection surface of the fixed reflection part and the fourth reflection surface of the movable reflection part and causes the collected light to enter the detection part.

3. The spectroscopic analysis device according to claim 2, wherein
the light supply part has a diffraction grating,
the incident parallel light formation part includes
a lens having a focal point at a position of the diffraction grating, and/or
the light collection part includes
a lens having a focal point at a position of a detection surface of the detection part.

4. The spectroscopic analysis device according to claim 2, wherein
the light collection part includes
a light-traveling direction change member that changes a traveling direction of light reflected at the second reflection surface of the fixed reflection part and the fourth reflection surface of the movable reflection part.

5. The spectroscopic analysis device according to claim 4, wherein
the light collection part includes
a lens having a focal point at a position of the detection surface of the detection part, and
the light-traveling direction change member is
a reflecting mirror having a reflection surface that reflects light collected by the lens, the reflecting mirror being provided between the lens and the detection surface of the detection part.

6. A spectroscopic analysis device comprising:
a light supply part;
an interfering light formation part that forms interfering light using entirety of supplied light supplied from the light supply part; and
a detection part that detects light intensity of the interfering light formed by the interfering light formation part, wherein
the interfering light formation part includes
a first reflection part and a second reflection part having reflection surfaces facing each other,
the second reflection part includes
a fixed reflection part whose movement is fixed with respect to the first reflection part,
a movable reflection part provided to be movable with respect to the first reflection part along a base plane orthogonal to an optical axis of the supplied light, and
a moving part that moves and fixes the movable reflection part along the base plane,
the first reflection part includes:
an incident part that has one incident reflection surface that reflects the supplied light supplied from the light supply part and uses the one incident reflection surface to allow entirety of the supplied light to be incident on the second reflection part as incident light that is parallel light; and
an outgoing part that has an outgoing reflection surface provided plane-symmetrically with the incident reflection surface of the incident part with respect to a symmetry plane parallel to the base plane and emits reflected light supplied from the second reflection part as interfering reflected light toward the detection part,
the fixed reflection part and the movable reflective part of the second reflection part are
provided so as to face the one incident reflection surface of the first reflection part,
the fixed reflection part of the second reflection part includes
a first reflection surface and a second reflection surface provided plane-symmetrically with respect to the symmetry plane,
the first reflection surface is
provided so as to face the incident reflection surface of the incident part of the first reflection part and to allow a part of the incident light to be incident thereon and reflect the incident light so that the incident light becomes first reflected light whose optical axis is parallel to the optical axis of the supplied light,
the second reflection surface is
provided so as to face the outgoing reflection surface of the outgoing part of the first reflection part and to allow the first reflected light to be incident thereon and reflect the first reflected light so that the first reflected light becomes second reflected light whose optical axis forms an angle with the base plane, the angle being same as an angle formed between the optical axis of the incident light and the symmetry plane,
the movable reflection part of the second reflection part includes
a third reflection surface and a fourth reflection surface parallel to the first reflection surface and the second reflection surface of the fixed reflection part, respectively,
the third reflection surface is
provided so as to face the incident surface of the incident part of the first reflection part and to allow a part of the incident light to be incident thereon and reflect the incident light so that the incident light becomes third reflected light whose optical axis is parallel to the optical axis of the supplied light, and
the fourth reflection surface is
provided so as to face the outgoing reflection surface of the outgoing part of the first reflection part and to allow the third reflected light to be incident thereon and reflect the third reflected light so that the third reflected light becomes fourth reflected light whose optical axis forms an angle with the base plane, the angle being same as an angle formed between the optical axis of the incident light and the symmetry plane.

7. The spectroscopic analysis device according to claim 6, wherein
the first reflection part has
the incident part with the incident reflection surface that is a parabolic surface, and
the outgoing part with the outgoing reflection surface that is a parabolic surface.

8. The spectroscopic analysis device according to claim 6, wherein
the first reflection part has
the incident part having a parallel light formation part that collimates the supplied light as parallel light,
the incident reflection surface of the incident part is
a flat surface that reflects the supplied light collimated as the parallel light by the parallel light formation part toward the second reflection part as the parallel light,
the outgoing reflection surface of the incident part is
a flat surface that reflects the reflected light supplied from the second reflection part at the detection part as interfering reflected light, and
the outgoing part includes
a light collection part that collects the interfering reflected light reflected at the outgoing reflection surface and allows the interfering reflected light to be incident on the detection unit.

9. The spectroscopic analysis device according to claim 6, wherein
a slit is provided between the light supply part and the incident reflection surface of the first reflection part.

10. The spectroscopic analysis device according to claim 6, wherein
the light supply part has
a parabolic surface that reflects light of supply toward the incident reflection surface of the first reflection part.

11. An interfering light formation mechanism that forms an interference image by dividing incident supplied light, the interfering light formation mechanism comprising:
a fixed reflection part whose movement is fixed; and
a movable reflection part provided to be movable relative to the fixed reflection part in parallel to a base plane, wherein
the fixed reflection part includes
a first reflection surface that reflects the supplied light and
a second reflection surface provided to be plane-symmetrical with the first reflection surface with respect to the base plane and to be orthogonal to the first reflection surface, and
the movable reflection part includes
a third reflection surface and a fourth reflection surface parallel to the first reflection surface and the second reflection surface of the fixed reflection part, respectively.

12. The interfering light formation mechanism according to claim 11, comprising:
an incident parallel light formation part that collimates the supplied light supplied from the light supply part as parallel light; and/or
a light collection part that collects light reflected at the second reflection surface of the fixed reflection part and the fourth reflection surface of the movable reflection part.

13. The interfering light formation mechanism according to claim 12, wherein
the incident parallel light formation part includes
a diffraction grating to be irradiated with the supplied light and
a lens having a focal point at a position of the diffraction grating.

14. The interfering light formation mechanism according to claim 12, wherein
the light collection part includes
a light-traveling direction change member that changes a traveling direction of light reflected at the second reflection surface of the fixed reflection part and the fourth reflection surface of the movable reflection part.

15. An interfering light formation mechanism that forms interfering light using entirety of incident supplied light, the interfering light formation mechanism comprising
a first reflection part and a second reflection part having reflection surfaces facing each other, wherein
the second reflection part includes
a fixed reflection part whose movement is fixed with respect to the first reflection part,
a movable reflection part provided to be movable with respect to the first reflection part along a base plane orthogonal to an optical axis of the supplied light, and
a moving part that moves and fixes the movable reflection part along the base plane,
the first reflection part has
an incident part that has one incident reflection surface that reflects the incident supplied light and uses the one incident reflection surface to allow entirety of the supplied light to be incident on the second reflection part as incident light that is parallel light, and
an outgoing part that has an outgoing reflection surface provided plane-symmetrically with the incident reflection surface of the incident part with respect to a symmetry plane parallel to the base plane and emits reflected light supplied from the second reflection part as interfering reflected light,
the fixed reflection part and the movable reflection part of the second reflection part are
provided so as to face the one incident reflection surface of the first reflection part,
the fixed reflection part of the second reflection part includes
a first reflection surface and a second reflection surface provided plane-symmetrically with respect to the symmetry plane,
the first reflection surface is
provided so as to face the incident reflection surface of the incident part of the first reflection part and to allow a part of the incident light to be incident thereon and reflect the incident light so that the incident light becomes first reflected light whose optical axis is parallel to the optical axis of the supplied light,
the second reflection surface is
provided so as to face the outgoing reflection surface of the outgoing part of the first reflection part and to allow the first reflected light to be incident thereon and reflect the first reflected light so that the first reflected light becomes second reflected light whose optical axis forms an angle with the base plane, the angle being same as an angle formed between the optical axis of the incident light and the symmetry plane,
the movable reflection part of the second reflection part includes
a third reflection surface and a fourth reflection surface parallel to the first reflection surface and the second reflection surface of the fixed reflection part, respectively,
the third reflection surface is
provided so as to face the incident surface of the first reflection part and to allow a part of the incident light to be incident thereon and reflect the incident light so that the incident light becomes third reflected light whose optical axis is parallel to the optical axis of the supplied light, and
the fourth reflection surface is
provided so as to face the outgoing reflection surface of the first reflection part and to allow the third reflected light to be incident thereon and reflect the third reflected light so that the third reflected light becomes fourth reflected light whose optical axis forms an angle with the symmetry plane, the angle being same as an angle formed between the optical axis of the incident light and the symmetry plane.

16. The interfering light formation mechanism according to claim 15, wherein
the first reflection part has
the incident part with the incident reflection surface that is a parabolic surface, and
the outgoing part with the outgoing reflection surface that is a parabolic surface.

17. The spectroscopic analysis device according to claim 15, wherein
the first reflection part has
the incident part with a parallel light formation part that collimates the incident supplied light as parallel light,
the incident reflection surface of the incident part is
a flat surface that reflects the supplied light collimated as the parallel light by the parallel light formation part toward the second reflection part as the parallel light,
the outgoing reflection surface of the incident part is
a flat surface that reflects the reflected light supplied from the second reflection part as interfering reflected light, and
the outgoing part includes
a light collection part that collects and emits the interfering reflected light reflected at the outgoing reflection surface.

18. The interfering light formation mechanism according to claim 15, comprising
a slit provided on an upstream side relative to the incident reflection surface of the first reflection part in an incident direction of the supplied light.
